(19) United States
(12) Patent Application Publication
(10) Pub. No.: US 2026/0122527 A1
(43) Pub. Date: Apr. 30, 2026

(54) CAPABILITY ELEMENT DESIGN FOR OPTIONAL WIRELESS FEATURES

(71) Applicant: QUALCOMM Incorporated, San Diego, CA (US)

(72) Inventors: Eugene BAIK, Sunnyvale, CA (US); Sameer VERMANI, San Diego, CA (US); Jialing Li CHEN, San Diego, CA (US); Lin YANG, San Diego, CA (US); Bin TIAN, San Diego, CA (US)

(21) Appl. No.: 18/929,384

(22) Filed: Oct. 28, 2024

(51) Int. Cl. H04W 28/02; H04L 1/00; H04L 5/00; H04W 28/18

(52) U.S. Cl. CPC H04W 28/0215; H04L 1/0063; H04L 5/0053; H04W 28/18

(57) ABSTRACT

Certain aspects of the present disclosure provides a method for signaling support for optional wireless features. According to certain aspects, an apparatus (e.g., an AP or non-AP STA) outputs at least one first element that indicates a capability of the apparatus to support one or more features considered optional for a communication session, obtains at least one second element that indicates a capability of a wireless node to support the one or more features for the communication session, and participates in the communication session with the wireless node in accordance with the capability indicated in at least one of the first element or the second element.

### TECHNICAL FIELD

This disclosure relates generally to wireless communication, and more specifically, to mechanisms for signaling support of optional wireless features.

### DESCRIPTION OF THE RELATED TECHNOLOGY

A wireless local area network (WLAN) may be formed by one or more wireless access points (APs) that provide a shared wireless communication medium for use by multiple client devices also referred to as wireless stations (STAs). The basic building block of a WLAN conforming to the Institute of Electrical and Electronics Engineers (IEEE) 802.11 family of standards is a Basic Service Set (BSS), which is managed by an AP. Each BSS is identified by a Basic Service Set Identifier (BSSID) that is advertised by the AP. An AP periodically broadcasts beacon frames to enable any STAs within wireless range of the AP to establish or maintain a communication link with the WLAN.

### SUMMARY

One innovative aspect of the subject matter described in this disclosure can be implemented in a method for wireless communication at a wireless node (e.g., a wireless STA or a wireless AP). The method includes outputting at least one first element that indicates a capability of the wireless node to support one or more features considered optional for a communication session; obtaining at least one second element that indicates a capability of a second wireless node to support the one or more features for the communication session; and participating in the communication session with the second wireless node in accordance with the capability indicated in at least one of the first element or the second element.

Other aspects provide: an apparatus operable, configured, or otherwise adapted to perform any one or more of the aforementioned methods and/or those described elsewhere herein; a non-transitory, computer-readable media comprising instructions that, when executed by a processor of an apparatus, cause the apparatus to perform the aforementioned methods as well as those described elsewhere herein; a computer program product embodied on a computer-readable storage medium comprising code for performing the aforementioned methods as well as those described elsewhere herein; and/or an apparatus comprising means for performing the aforementioned methods as well as those described elsewhere herein. By way of example, an apparatus may comprise a processing system, a device with a processing system, or processing systems cooperating over one or more networks.

The following description and the appended figures set forth certain features for purposes of illustration.

### BRIEF DESCRIPTION OF THE DRAWINGS

FIG. 1 shows a pictorial diagram of an example wireless communication network.

FIG. 2 shows an example protocol data unit (PDU) usable for communications between a wireless access point (AP) and one or more wireless stations (STAs).

FIG. 3 shows a hierarchical format of an example physical layer PDU (PPDU) usable for communications between a wireless AP and one or more wireless STAs.

FIGS. 4 and 5 show pictorial diagrams of example wireless communication networks, in which coordinated beamforming (CoBF) may be utilized.

FIGS. 6A, 6B, and 7 show example timing diagrams for channel state information (CSI) feedback for CoBF.

FIG. 8 shows an example call flow diagram for indicating support of optional wireless features, in accordance with aspects of the present disclosure.

FIGS. 9-13 show example mechanisms for signaling support of an optional codeword size, in accordance with aspects of the present disclosure.

FIGS. 14-16 show example mechanisms for signaling support of an optional modulation and coding schemes (MCSs), in accordance with aspects of the present disclosure.

FIGS. 17-23 show example mechanisms for signaling support of unequal modulation (UEQM) for different streams within a packet, in accordance with aspects of the present disclosure.

FIGS. 24-28 show example mechanisms for signaling support of distributed resource units (DRUs), in accordance with aspects of the present disclosure.

FIGS. 29-32 show example mechanisms for signaling support of extended long range (ELR) features, in accordance with aspects of the present disclosure.

FIGS. 33-36 show example mechanisms for signaling support of CoBF, in accordance with aspects of the present disclosure.

FIG. 37 shows an example mechanism for signaling support of coordinate spatial reuse (CSR), in accordance with aspects of the present disclosure.

FIG. 38 shows an example mechanism for signaling support of an interference mitigation mechanism (IMM), in accordance with aspects of the present disclosure.

FIG. 39 shows an example flowchart illustrating example processes performable by or at a wireless node, in accordance with aspects of the present disclosure.

FIG. 40 shows a block diagram of an example wireless communication device

Like reference numbers and designations in the various drawings indicate like elements.

### DETAILED DESCRIPTION

The following description is directed to some particular examples for the purposes of describing innovative aspects of this disclosure. However, a person having ordinary skill in the art will readily recognize that the teachings herein can be applied in a multitude of different ways. Some or all of the described examples may be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G or 5G (New Radio (NR)) standards promulgated by the 3^{rd} Generation Partnership Project (3GPP), among others. The described examples can be implemented in any device, system or network that is capable of transmitting and receiving RF signals according to one or more of the following technologies or techniques: code division multiple access (CDMA), time division multiple access (TDMA), frequency division multiple access (FDMA), orthogonal FDMA (OFDMA), single-carrier FDMA (SC-FDMA), spatial division multiple access (SDMA), rate-splitting multiple access (RSMA), multi-user shared access (MUSA), single-user (SU) multiple-input multiple-output (MIMO) and multi-user (MU)-MIMO. The described examples also can be implemented using other wireless communication protocols or RF signals suitable for use in one or more of a wireless personal area network (WPAN), a wireless local area network (WLAN), a wireless wide area network (WWAN), a wireless metropolitan area network (WMAN), or an internet of things (IOT) network.

In order to address the issue of increasing bandwidth requirements that are demanded for wireless communication systems, different schemes are being developed to allow multiple user terminals to communicate with a single access point (AP) or multiple APs by sharing the channel resources while achieving high data throughputs. Multiple Input Multiple Output (MIMO) technology represents one such approach that has recently emerged as a popular technique for the next generation communication systems.

A MIMO system employs multiple (N_{T}) transmit antennas and multiple (NR) receive antennas for data transmission. A MIMO channel formed by the N_{T} transmit and N_{R} receive antennas may be decomposed into NS independent channels, which are also referred to as spatial channels, where N_{S}≤min{N_{T}, N_{R}}. Each of the NS independent channels corresponds to a dimension. The MIMO system can provide improved performance (such as higher throughput and greater reliability) if the additional dimensionalities created by the multiple transmit and receive antennas are utilized.

In wireless networks with multiple APs and multiple user stations (STAs), concurrent transmissions may occur on multiple channels toward different STAs, both in uplink and downlink directions. Various challenges are present in such systems.

For example, the APs and STAs may transmit signals according to one or more different wireless standards that support different features. Certain features may be optional in a particular standard. In other words, these certain features may not be mandatory, in the sense that a device may be considered compliant with the standard but not support the feature. Further, a device may choose to disable such features for various reasons, such as performance or power consumption considerations.

As a result, APs and STAs typically need to exchange capability information to determine what features will be supported for a given communication session. Unfortunately, the exchange of capability information comes at a cost of signaling overhead. Further, many optional features may have various options, which may result in even greater signaling overhead.

Aspects of the present disclosure provide various mechanisms for signaling support for features considered optional for a wireless communications session. Particular aspects of the subject matter described in this disclosure can be implemented to realize one or more of the following potential advantages. In some examples, efficient signaling mechanisms may help reduce signaling overhead. In some examples, certain fields or subfields of existing signaling mechanisms may be re-purposed to indicate support (or lack thereof) for certain optional features. For example, certain fields, subfields, or bits thereof, may not be applicable in certain scenarios, allowing these to be re-purposed to indicate capability information.

### Example Wireless Communication Network

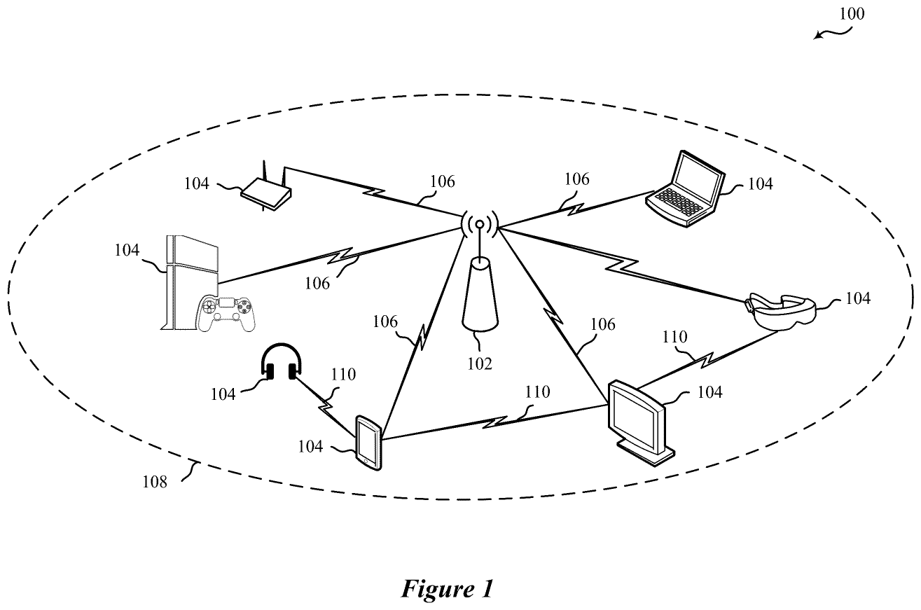

FIG. 1 shows a pictorial diagram of an example wireless communication network 100. The wireless communication network 100 includes various wireless nodes (such as AP STAs and non-AP STAs). According to some aspects, the wireless communication network 100 can be an example of a wireless local area network (WLAN) such as a Wi-Fi network. For example, the wireless communication network 100 can be a network implementing at least one of the IEEE 802.11 family of wireless communication protocol standards (such as defined by the IEEE 802.11-2020 specification or amendments thereof including, but not limited to, 802.11ay, 802.11ax, 802.11az, 802.11ba, 802.11bd, 802.11be, 802.11bf, and 802.11bn). In some other examples, the wireless communication network 100 can be an example of a cellular radio access network (RAN), such as a 5G or 6G RAN that implements one or more cellular protocols such as those specified in one or more 3GPP standards. In some other examples, the wireless communication network 100 can include a WLAN that functions in an interoperable or converged manner with one or more cellular RANs to provide greater or enhanced network coverage to wireless communication devices within the wireless communication network 100 or to enable such devices to connect to a cellular network's core, such as to access the network management capabilities and functionality offered by the cellular network core.

The wireless communication network 100 may include numerous wireless communication devices including at least one wireless access point (AP) 102 and any number of wireless stations (STAs) 104. While only one AP 102 is shown in FIG. 1, the wireless communication network 100 can include multiple APs 102. The AP 102 can be or represent various different types of network entities including, but not limited to, a home networking AP, an enterprise-level AP, a single-frequency AP, a dual-band simultaneous (DBS) AP, a tri-band simultaneous (TBS) AP, a standalone AP, a non-standalone AP, a software-enabled AP (soft AP), and a multi-link AP (also referred to as an AP multi-link device (MLD)), as well as cellular (such as 3GPP, 4G LTE, 5G or 6G) base stations or other cellular network nodes such as a Node B, an evolved Node B (eNB), a gNB, a transmission reception point (TRP) or another type of device or equipment included in a radio access network (RAN), including Open-RAN (O-RAN) network entities, such as a central unit (CU), a distributed unit (DU) or a radio unit (RU).

Each of the STAs 104 also may be referred to as a mobile station (MS), a mobile device, a mobile handset, a wireless handset, an access terminal (AT), a user equipment (UE), a subscriber station (SS), or a subscriber unit, among other examples. The STAs 104 may represent various devices such as mobile phones, other handheld or wearable communication devices, netbooks, notebook computers, tablet computers, laptops, Chromebooks, augmented reality (AR), virtual reality (VR), mixed reality (MR) or extended reality (XR) wireless headsets or other peripheral devices, wireless earbuds, other wearable devices, display devices (for example, TVs, computer monitors or video gaming consoles), video game controllers, navigation systems, music or other audio or stereo devices, remote control devices, printers, kitchen appliances (including smart refrigerators) or other household appliances, key fobs (for example, for passive keyless entry and start (PKES) systems), Internet of Things (IoT) devices, and vehicles, among other examples.

A single AP 102 and an associated set of STAs 104 may be referred to as a basic service set (BSS), which is managed by the respective AP 102. FIG. 1 additionally shows an example coverage area 108 of the AP 102, which may represent a basic service area (BSA) of the wireless communication network 100. The BSS may be identified by STAs 104 and other devices by a service set identifier (SSID), as well as a basic service set identifier (BSSID), which may be a medium access control (MAC) address of the AP 102. The AP 102 may periodically broadcast beacon frames (“beacons”) including the BSSID to enable any STAs 104 within wireless range of the AP 102 to “associate” or re-associate with the AP 102 to establish a respective communication link 106 (hereinafter also referred to as a “Wi-Fi link”), or to maintain a communication link 106, with the AP 102. For example, the beacons can include an identification or indication of a primary channel used by the respective AP 102 as well as a timing synchronization function (TSF) for establishing or maintaining timing synchronization with the AP 102. The AP 102 may provide access to external networks to various STAs 104 in the wireless communication network 100 via respective communication links 106.

To establish a communication link 106 with an AP 102, each of the STAs 104 is configured to perform passive or active scanning operations (“scans”) on frequency channels in one or more frequency bands (for example, the 2.4 GHz, 5 GHz, 6 GHz, 45 GHz, or 60 GHz bands). To perform passive scanning, a STA 104 listens for beacons, which are transmitted by respective APs 102 at periodic time intervals referred to as target beacon transmission times (TBTTs). To perform active scanning, a STA 104 generates and sequentially transmits probe requests on each channel to be scanned and listens for probe responses from APs 102. Each STA 104 may identify, determine, ascertain, or select an AP 102 with which to associate in accordance with the scanning information obtained through the passive or active scans, and to perform authentication and association operations to establish a communication link 106 with the selected AP 102. The selected AP 102 assigns an association identifier (AID) to the STA 104 at the culmination of the association operations, which the AP 102 uses to track the STA 104.

As a result of the increasing ubiquity of wireless networks, a STA 104 may have the opportunity to select one of many BSSs within range of the STA 104 or to select among multiple APs 102 that together form an extended service set (ESS) including multiple connected BSSs. For example, the wireless communication network 100 may be connected to a wired or wireless distribution system that may enable multiple APs 102 to be connected in such an ESS. As such, a STA 104 can be covered by more than one AP 102 and can associate with different APs 102 at different times for different transmissions. Additionally, after association with an AP 102, a STA 104 also may periodically scan its surroundings to find a more suitable AP 102 with which to associate. For example, a STA 104 that is moving relative to its associated AP 102 may perform a “roaming” scan to find another AP 102 having more desirable network characteristics such as a greater received signal strength indicator (RSSI) or a reduced traffic load.

In some cases, STAs 104 may form networks without APs 102 or other equipment other than the STAs 104 themselves. One example of such a network is an ad hoc network (or wireless ad hoc network). Ad hoc networks may alternatively be referred to as mesh networks or peer-to-peer (P2P) networks. In some cases, ad hoc networks may be implemented within a larger network such as the wireless communication network 100. In such examples, while the STAs 104 may be capable of communicating with each other through the AP 102 using communication links 106, STAs 104 also can communicate directly with each other via direct wireless communication links 110. Additionally, two STAs 104 may communicate via a direct communication link 110 regardless of whether both STAs 104 are associated with and served by the same AP 102. In such an ad hoc system, one or more of the STAs 104 may assume the role filled by the AP 102 in a BSS. Such a STA 104 may be referred to as a group owner (GO) and may coordinate transmissions within the ad hoc network. Examples of direct wireless communication links 110 include Wi-Fi Direct connections, connections established by using a Wi-Fi Tunneled Direct Link Setup (TDLS) link, and other P2P group connections.

In some networks, the AP 102 or the STAs 104, or both, may support applications associated with high throughput or low-latency requirements, or may provide lossless audio to one or more other devices. For example, the AP 102 or the STAs 104 may support applications and use cases associated with ultra-low-latency (ULL), such as ULL gaming, or streaming lossless audio and video to one or more personal audio devices (such as peripheral devices) or AR/VR/MR/XR headset devices. In scenarios in which a user uses two or more peripheral devices, the AP 102 or the STAs 104 may support an extended personal audio network enabling communication with the two or more peripheral devices. Additionally, the AP 102 and STAs 104 may support additional ULL applications such as cloud-based applications (such as VR cloud gaming) that have ULL and high throughput requirements.

As indicated above, in some implementations, the AP 102 and the STAs 104 may function and communicate (via the respective communication links 106) according to one or more of the IEEE 802.11 family of wireless communication protocol standards. These standards define the WLAN radio and baseband protocols for the physical (PHY) and MAC layers. The AP 102 and STAs 104 transmit and receive wireless communications (hereinafter also referred to as “Wi-Fi communications” or “wireless packets”) to and from one another in the form of PHY protocol data units (PPDUs).

Each PPDU is a composite structure that includes a PHY preamble and a payload that is in the form of a PHY service data unit (PSDU). The information provided in the preamble may be used by a receiving device to decode the subsequent data in the PSDU. In instances in which a PPDU is transmitted over a bonded or wideband channel, the preamble fields may be duplicated and transmitted in each of multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is associated with the particular IEEE 802.11 wireless communication protocol to be used to transmit the payload.

The APs 102 and STAs 104 in the WLAN 100 may transmit PPDUs over an unlicensed spectrum, which may be a portion of spectrum that includes frequency bands traditionally used by Wi-Fi technology, such as the 2.4 GHz, 5 GHz, 6 GHz, 45 GHz, and 60 GHz bands. Some examples of the APs 102 and STAs 104 described herein also may communicate in other frequency bands that may support licensed or unlicensed communications. For example, the APs 102 or STAs 104, or both, also may be capable of communicating over licensed operating bands, where multiple operators may have respective licenses to operate in the same or overlapping frequency ranges. Such licensed operating bands may map to or be associated with frequency range designations of FR1 (410 MHz-7.125 GHz), FR2 (24.25 GHz-52.6 GHz), FR3 (7.125 GHz-24.25 GHz), FR4a or FR4-1 (52.6 GHz-71 GHz), FR4 (52.6 GHz-114.25 GHz), and FR5 (114.25 GHz-300 GHz).

Each of the frequency bands may include multiple sub-bands and frequency channels (also referred to as subchannels). For example, PPDUs conforming to the IEEE 802.11n, 802.11ac, 802.11ax, 802.11be and 802.11bn standard amendments may be transmitted over one or more of the 2.4 GHz, 5 GHz, or 6 GHz bands, each of which is divided into multiple 20 MHz channels. As such, these PPDUs are transmitted over a physical channel having a minimum bandwidth of 20 MHz, but larger channels can be formed through channel bonding. For example, PPDUs may be transmitted over physical channels having bandwidths of 40 MHz, 80 MHz, 160 MHz, 240 MHz, 320 MHz, 480 MHz, or 640 MHz by bonding together multiple 20 MHz channels.

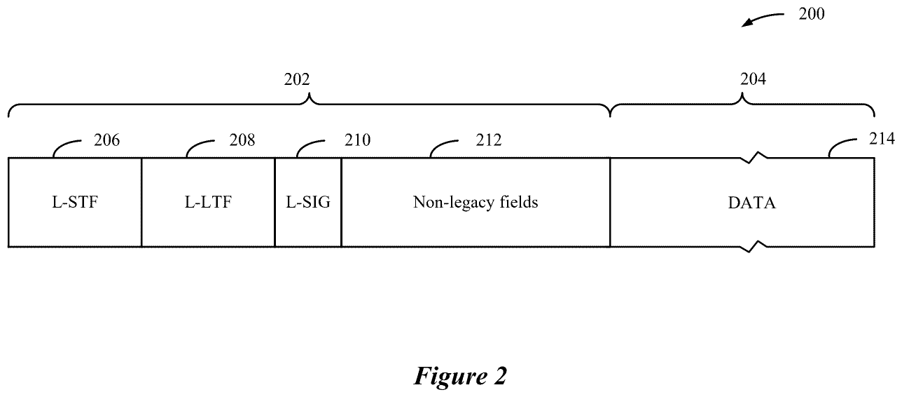

FIG. 2 shows an example protocol data unit (PDU) 200 usable for wireless communication between a wireless AP 102 and one or more wireless STAs 104. For example, the PDU 200 can be configured as a PPDU. As shown, the PDU 200 includes a PHY preamble 202 and a PHY payload 204. For example, the preamble 202 may include a legacy portion that itself includes a legacy short training field (L-STF) 206, which may consist of two symbols, a legacy long training field (L-LTF) 208, which may consist of two symbols, and a legacy signal field (L-SIG) 210, which may consist of two symbols. The legacy portion of the preamble 202 may be configured according to the IEEE 802.11a wireless communication protocol standard. The preamble 202 also may include a non-legacy portion including one or more non-legacy fields 212, for example, conforming to one or more of the IEEE 802.11 family of wireless communication protocol standards.

The L-STF 206 generally enables a receiving device to perform coarse timing and frequency tracking and automatic gain control (AGC). The L-LTF 208 generally enables a receiving device to perform fine timing and frequency tracking and also to perform an initial estimate of the wireless channel. The L-SIG 210 generally enables a receiving device to determine (for example, obtain, select, identify, detect, ascertain, calculate, or compute) a duration of the PDU and to use the determined duration to avoid transmitting on top of the PDU. The legacy portion of the preamble, including the L-STF 206, the L-LTF 208 and the L-SIG 210, may be modulated according to a binary phase shift keying (BPSK) modulation scheme. The payload 204 may be modulated according to a BPSK modulation scheme, a quadrature BPSK (Q-BPSK) modulation scheme, a quadrature amplitude modulation (QAM) modulation scheme, or another appropriate modulation scheme. The payload 204 may include a PSDU including a data field (DATA) 214 that, in turn, may carry higher layer data, for example, in the form of MAC protocol data units (MPDUs) or an aggregated MPDU (A-MPDU).

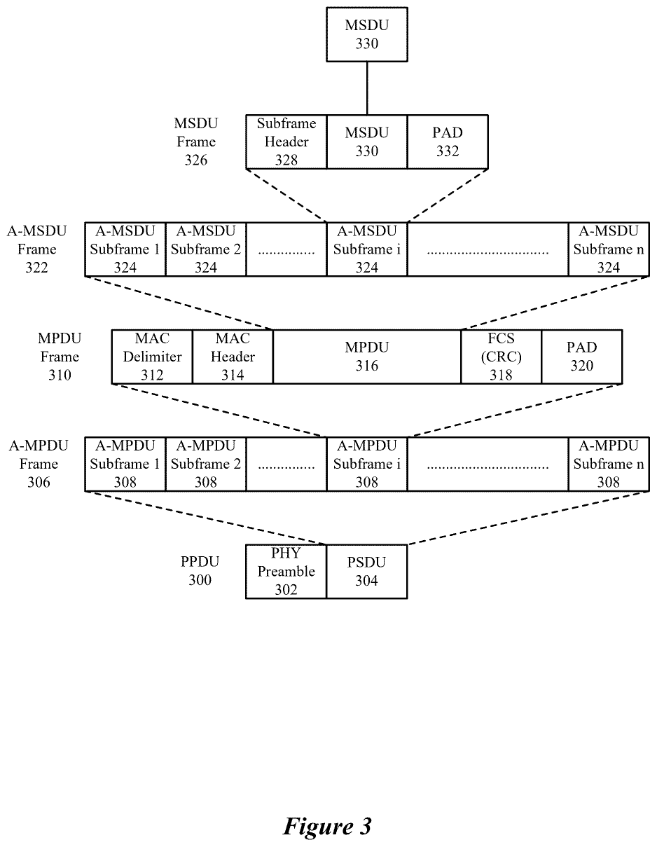

FIG. 3 shows a hierarchical format of an example PPDU usable for communications between a wireless AP 102 and one or more wireless STAs 104. As described, each PPDU 300 includes a PHY preamble 302 and a PSDU 304. Each PSDU 304 may represent (or “carry”) one or more MAC protocol data units (MPDUs) 316. For example, each PSDU 304 may carry an aggregated MPDU (A-MPDU) 306 that includes an aggregation of multiple A-MPDU subframes 308. Each A-MPDU subframe 306 may include an MPDU frame 310 that includes a MAC delimiter 312 and a MAC header 314 prior to the accompanying MPDU 316, which includes the data portion (“payload” or “frame body”) of the MPDU frame 310. Each MPDU frame 310 also may include a frame check sequence (FCS) field 318 for error detection (for example, the FCS field may include a cyclic redundancy check (CRC)) and padding bits 320. The MPDU 316 may carry one or more MAC service data units (MSDUs). For example, the MPDU 316 may carry an aggregated MSDU (A-MSDU) 322 including multiple A-MSDU subframes 324. Each A-MSDU subframe 324 contains a corresponding MSDU 330 preceded by a subframe header 328 and in some cases followed by padding bits 332.

Referring back to the MPDU frame 310, the MAC delimiter 312 may serve as a marker of the start of the associated MPDU 316 and indicate the length of the associated MPDU 316. The MAC header 314 may include multiple fields containing information that defines or indicates characteristics or attributes of data encapsulated within the frame body 316. The MAC header 314 includes a duration field indicating a duration extending from the end of the PPDU until at least the end of an acknowledgment (ACK) or Block ACK (BA) of the PPDU that is to be transmitted by the receiving wireless communication device. The use of the duration field serves to reserve the wireless medium for the indicated duration, and enables the receiving device to establish its network allocation vector (NAV). The MAC header 314 also includes one or more fields indicating addresses for the data encapsulated within the frame body 316. For example, the MAC header 314 may include a combination of a source address, a transmitter address, a receiver address or a destination address. The MAC header 314 may further include a frame control field containing control information. The frame control field may specify a frame type, for example, a data frame, a control frame, or a management frame.

### Example Coordinated Communications

In downlink (DL) multi-user multiple-input-multiple-output (MU-MIMO), multiple stations may belong to one basic service set (BSS) transmitting in the DL. Other BSSs (OBSSs) within “hearing” range may defer (not transmit on the medium) in response to detecting an on-going transmission. Different BSSs in hearing range of each other may use time-divisional multiplexing (TDM) to transmit in the DL. In coordinated UL MU-MIMO, multiple BSSs carry out simultaneous UL transmissions. Un-used receive spatial dimensions at the AP may be used to null the interference from the other BSS (OBSS) transmissions. This enables a greater degree of spatial multiplexing when there are un-used spatial dimension within the BSS. In other words, the un-used spatial dimensions may allow for concurrent OBSS transmissions in DL.

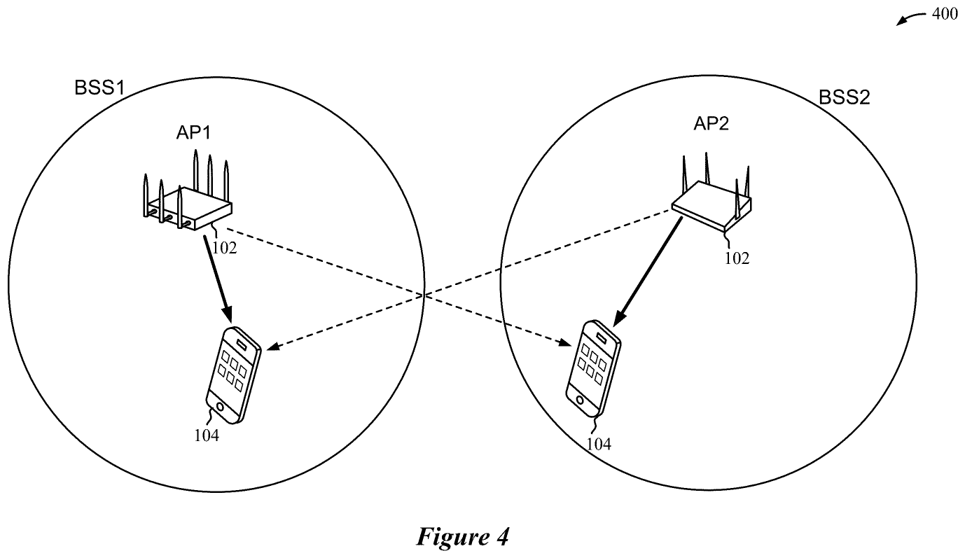

FIG. 4 illustrates a communication system 400 using coordinated DL MU-MIMO, in accordance with certain aspects of the present disclosure. As illustrated, the signal from each AP 102 is transmitted to only stations within their respective BSSs, as shown by the solid lines representing data transmissions from the AP the STAs 104 that are associated with the AP. The data transmissions from the APs cause interference to the other OBSS stations, as illustrated by the dotted lines. Un-used dimensions at the AP may be used to get rid of (e.g., null out) interference from OBSS APs.

In uplink (UL) multi-user multiple-input-multiple-output (MU-MIMO), multiple stations belonging to one BSS may transmit in the UL. Other BSSs within range may defer to an on-going transmission. Different BSSs in range of each other may use time-divisional multiplexing (TDM) to transmit in the UL. In coordinated UL MU-MIMO, multiple BSSs carry out simultaneous UL transmissions. As with DL MU-MIMO, un-used receive spatial dimensions at an AP may be used to null the interference from the other BSS (OBSS) transmissions, enabling a greater degree of spatial multiplexing and allowing for concurrent OBSS transmissions.

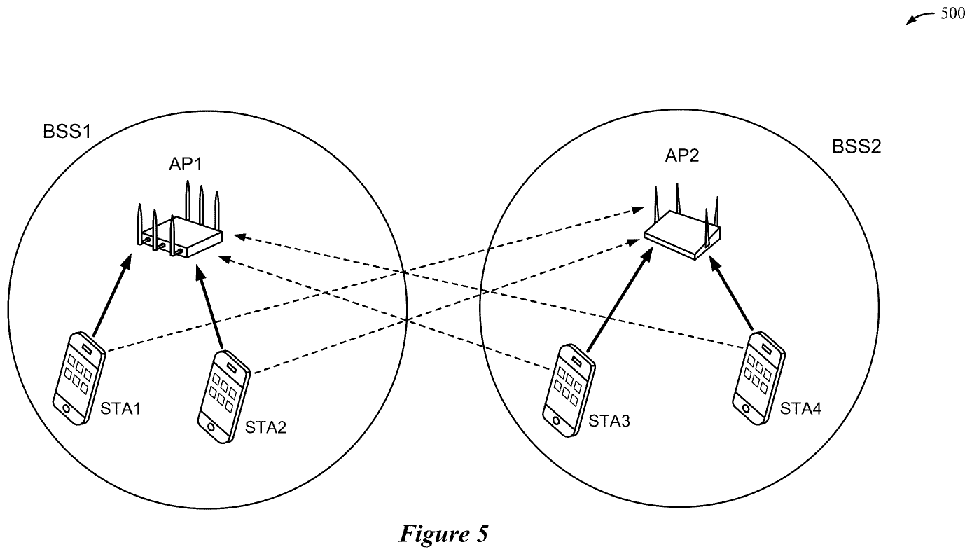

FIG. 5 illustrates an example system 500 that may utilize coordinated UL MU-MIMO. As illustrated, the signal from each STA 104 may be transmitted to only one AP 102 within their respective BSSs, as shown by the solid lines representing data transmissions to the AP the STAs are associated with. The data transmissions from the STAs cause interference to the other OBSS APs, as illustrated by the dotted lines. Un-used spatial dimensions at each AP may be used to mitigate (e.g., reduce or null out) interference from OBSS STAs.

Coordinated beamforming (CoBF) may include one or more protocols for coordinating (e.g., synchronizing) transmissions from different entities, for example, to form nulls to control interference to STAs of other OBSS, while transmitting to own (BSS) STAs.

### Example Coordinated Beamforming

As previously described, in CoBF, multiple APs may coordinate to suppress OBSS interference in the spatial domain. As such, CoBF typically provides gains in an opportunistic manner, for example, when in-BSS transmissions are not fully utilizing that BSS AP's spatial dimensions.

There are various types of CoBF, such as symmetric CoBF with synchronized or asynchronized transmission and asymmetric CoBF with synchronized or asynchronized transmission. With symmetric CoBF, all APs may participate in coordinated beamforming and to suppress their obsess interference to other victim STAs within other BSSs. With asymmetric CoBF, one device (or set of devices) may have higher or lower priority than other devices and/or may lack the capability to suppress OBSS interference.

In general, there can be multiple APs participating in CoBF. To facilitate understanding, however, example techniques will be described herein with reference to a CoBF scenario involving 2 APs. The techniques described herein may be extended to systems involving any number of APs.

The techniques described herein involve various processing for sounding and CSI feedback in CoBF. The techniques described herein may be applied to symmetric CoBF and asymmetric CoBF. As described above, in CoBF, an AP may obtain CSI from OBSS non-AP STA(s) to form nulls to the STA(s). This may involve cross BSS sounding and CSI feedback from non-AP STA(s) to OBSS AP(s). Each AP may also obtain CSI from its own serving non-AP STA(s) to form beams to those STA(s)

In asymmetric CoBF, sounding may involve transmission of just one packet, such as a null data packet (NDP), from a secondary AP to primary recipient. In symmetric CoBF, each AP may send out an NDP to sound the intended and interfering channels. In this context, sounding generally refers to a mechanism used to gather information about the characteristics of a communication channel, in order to optimize transmission parameters to improve the overall performance of CoBF. Sounding typically involves sending specific probe frames or signals and then analyzing the responses that provide CSI feedback, to understand the channel behavior.

There are various options for sounding, for example, involving sending out NDPs to solicit CSI feedback for intended and interfering channels. In this context, an intended channel may refer to a channel between an AP and a non-AP STA served by that AP (in a same BSS), while an interfering channel may refer to a channel between an OBSS AP and a non-AP STA.

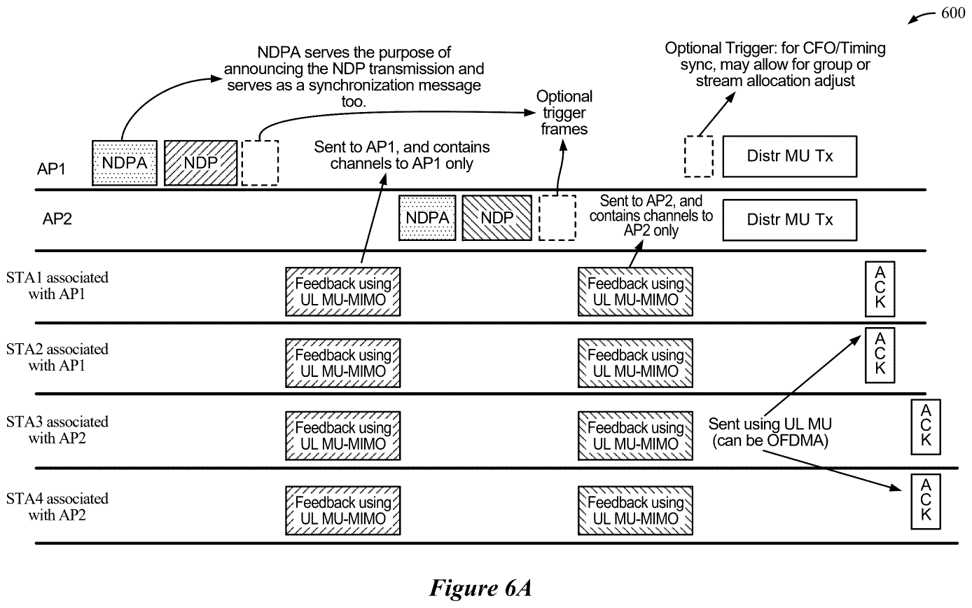

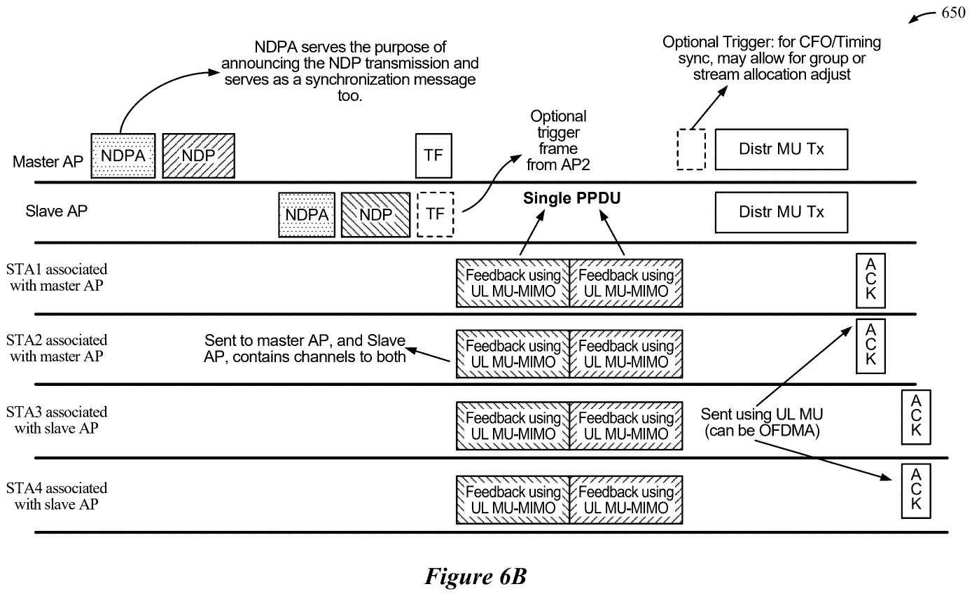

According to a first option, as illustrated in diagram 600 of FIG. 6A, each AP sends one NDP to intended and victim STAs, in a sequential manner.

In such cases, the BSS color of the AP may be included in the NDP so each STAs knows from which AP the NDP (and estimated channel) comes from. In the illustrated example, two APs (e.g., AP1 and AP2 of FIG. 5) send sequential NDPs. Based on the NDP sent from the j-th AP, each STA (the i-th STA) estimates the channel, Hᵢⱼ, channel matrix from j-th AP to the i-th STA.

As illustrated in diagram 650 of FIG. 6B, in some cases, non-AP STAs may not send CSI feedback until after all NDPs are sent and all channels are estimated.

In the illustrated example, AP1 send an NDPA and NDP, then AP2 sends an NDPA and NDP. AP1 sends a Trigger frame (TF) and at the same time AP2 may send an optional TF, triggering the STAs to send CSI feedback to both APs. To generate the CSI feedback, the non-AP STAs could use the enhanced CSI processing and small V feedback techniques described herein. The non-AP STAs could also use the large V feedback of the composite channels, provided the phase and automatic gain control (AGC) at each non-AP STAs use the same phase and AGC setting when processing all of NDP packets.

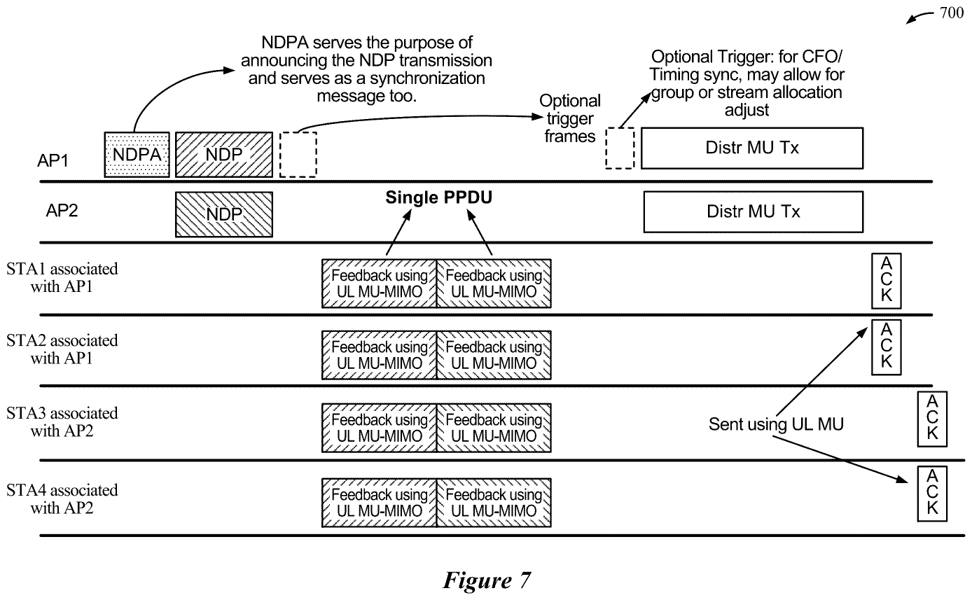

According to a second option, as illustrated in diagram 700 of FIG. 7, APs participating in CoBF collaboratively send out a joint NDP to all serving STAs. The NDP may be considered a joint NDP, even though it is sent from two different APs.

In this context, a joint NDP may be one PPDU sent from both APs, with identical information (transmitted by each AP) in all fields except in a long training field (e.g., a UHR-LTF) field. In the LTF, each AP may send different streams and the streams sent from different APs may use mutually different indices. In this manner, all APs may share a joint LTF, where the first subset of streams are sent from 1st AP, and second subset of streams are sent from a 2nd AP, so that the estimated channel is a composite channel where first subset of streams are from 1st AP and second subset of streams are from 2nd AP.

The joint NDP may use a group BSS color for the group of CoBF APs. The group BSS color may be sent in a prior packet, such as an NDP announcement (NDPA) frame from one of the APs (e.g., a sharing AP), before the joint NDP.

According to certain aspects of the present disclosure, to aid in CSI processing by a non-AP STA, a joint NDP may indicate which part of composite channel comes from which AP. For example, the joint NDP (or some other signaling mechanism) may signal the numbers of Tx antennas or streams from different APs, i.e., [N_tx_1, N_tx_2, . . . ] or [N_ss_1, N_ss_2, . . . ] and the list of CoBF BSS IDs in NDPA, so that STAs know which part of composite channel comes from intended AP and which part comes from interfering AP(s). Alternatively, the joint NDP (or some other signaling mechanism) may signal the starting stream indices for different APs and the list of CoBF BSS IDs in NDPA. If the numbers of Tx antennas or streams from different APs or the start stream indices for different APs are signaled, they may be in a prior packet, e.g., NDPA, or in the joint NDP packet (e.g., in U-SIG or the common field of the UHR-SIG).

With joint sounding, each STA (the i-th STA) may estimate the composite channel matrix at from Nₐₚ APs as Hᵢ=[Hᵢ₁ Hᵢ₂ . . . H_{iN}_{ₐₚ}], where each Hij represents a channel matrix for a channel between STAi and APj. Joint NDP may have less overhead, and may help with enhanced coordinated spatial reuse (CSR) and/or joint transmission (JT) to a single or multiple STAs.

Aspects of the present disclosure also provide various options for sending CSI feedback, including cross-BSS CSI feedback. In some cases, a backhaul (e.g., a light backhaul) between APs may be used for CSI exchange. In such cases, all STAs may send CSI feedbacks to their own APs and the APs may share with each other (exchanging CSI feedback) over the backhaul. In this case, UL transmissions (of CSI-FB) to own APs may be done in parallel, for example, if using coordinated UL MU-MIMO or coordinated UL OFDMA.

In some cases, if there is no backhaul, it may be assumed that coordinated UL MU-MIMO is used. In such cases, STAs may transmit to their own APs in parallel, then the STAs may transmit to OBSS in APs in parallel. In other cases, coordinated UL MU-MIMO may not be assumed, though this may mean both APs do not receive simultaneously and, hence, may have additional latency for each STA to feedback to all the APs one at a time.

In some cases, coordinated UL MU-MIMO may involve CoBF, with un-utilized spatial dimensions of the AP used to perform receive (Rx) nulling of OBSS UL transmissions.

Aspects of the present disclosure provide various options that may be applied in both point-to-point channel CSI processing and feedback and composite channel CSI processing and feedback.

In this context, point-to-point channel feedback generally refers to the CSI feedback of a channel between two STAs, such as an AP and a non-AP STA (e.g., with a channel matrix Hᵢⱼ for APj and STAi). For point-to-point channel feedback, there are also various sub-options with different types of CSI processing (to generate the CSI feedback) and different types of content fed back (as CSI feedback).

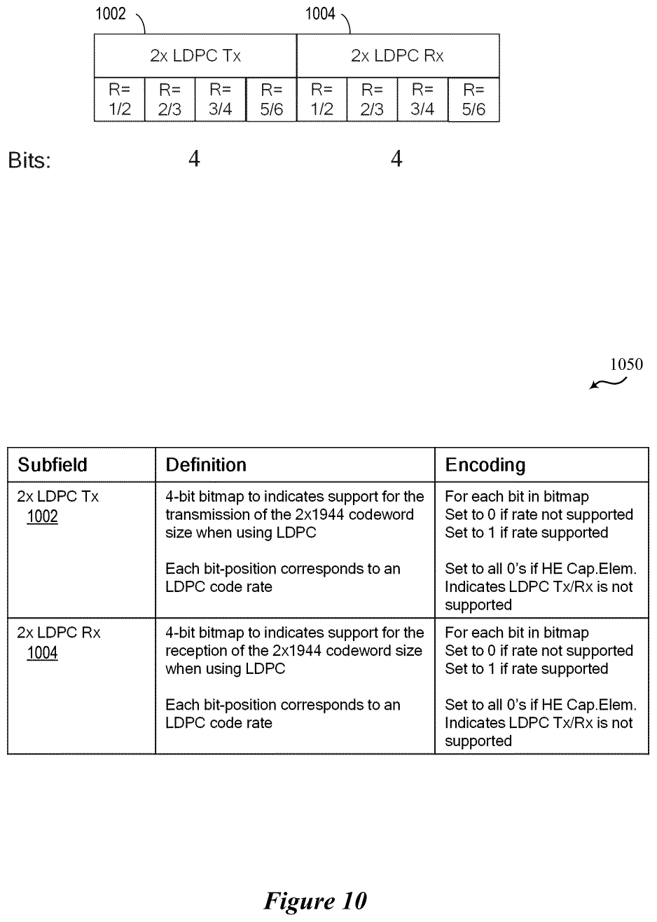

A composite channel may be either point to multi-point (e.g., from one AP to multiple non-AP STAs) or multi-point to single point (e.g., from multiple APs to a single STA). In this context, composite channel feedback generally refers to the CSI feedback of a composite channel, such as the channel from multiple APs (e.g., an in-BSS and OBSS AP) to a single STA (Hᵢ). As will be described below with reference to FIG. 10, aspects of the present disclosure provide techniques for a non-AP STA to generate composite channel CSI feedback and for an AP to reconstruct point-to-point channel CSI from the composite channel CSI feedback.

Point-to-point Channel CSI processing and feedback may be performed as follows. An N_{rx,i}×N_{tx,j} channel matrix from a j-th AP (APj) to an i-th STA (STAi) may be denoted as Hᵢⱼ where N_{rx,i} is the number (quantity) of receive antennas of APj and N_{tx,j} is the number of transmit antennas from APj (and N_{rx,j}≤N_{tx,j}).

Based on the channel estimation of a packet (e.g., an NDP) from APj, STAi may obtain the channel matrix Hᵢⱼ and perform a singular value decomposition (SVD) on Hᵢⱼ to obtain:

$${H}_{ij} = {U}_{ij} \cdot {S}_{ij} \cdot {V}_{ij}^{′} ,$$

where Uᵢⱼ is an N_{rx,i}×N_{rx,i} (left semi-unitary or) unitary matrix, Sᵢⱼ is an N_{rx,j}×N_{rx,i} diagonal matrix with the singular values of the channel Hᵢⱼ, and Vᵢ is an N_{tx,j}×N_{rx,i} (right) semi-unitary (or unitary) matrix.

In some cases, CSI feedback may be what is referred to as small V feedback. With small V feedback, STAi feeds back Sᵢⱼ and Vᵢⱼ of requested rank N_{fb,i}, i.e., S_{fb,ij}=Sᵢⱼ(1:N_{fb,i}:N_{fb,i}) and V_{fb,ij}=Vᵢⱼ (:, 1:N_{fb,i}), where the requested rank may be signaled to the STA in a prior packet, e.g., NDPA. The notation of A(i:j, k:l) represents a submatrix of A, by selecting from the i-th to j-th rows and from the k-th to l-th columns. The notation “:” in a submatrix A(:, k:) represents a submatrix of A, by selecting all rows and from the k-th to 1-th columns. Likewise, the notation “:” in a submatrix A(i:j, :) represents a submatrix of A, by selecting from the i-th to j-th rows and all columns. In this manner, an AP may request CSI feedback (of certain matrices) to be of a certain rank (or number of columns). For example, an SVD may produce 4 Eigen channels, but the AP may only request a rank of 2 or 3 in a CSI feedback request.

In the case of small V feedback, the reconstructed channel

$${rH}_{ij} = {S}_{fb , ij} \cdot {V}_{fb , ij}^{′}$$

corresponds to the Eigen channels using the

$${U}_{nfb , ij}^{′}$$

receiver (which is not fed back), where U_{nfb,ij}=Uᵢⱼ(:, 1:N_{fb,i}). In this case, the full channel Hᵢⱼ may not be reconstructed, which may result in less than optimal CoBF.

According to one of the sub-options presented herein, however, STAi may use a CSI processing technique for the small V feedback of the intended and interfering channels based on the same receiver.

One example of this first sub-option for point-to-point channel CSI processing and feedback may assume AP1 (BSS1) and AP2 (BSS2) transmit NDP(s) for sounding. In such cases, STA1 may generate, based on the NDP(s), CSI FB for intended channel (between AP1 and STA1) based on SVD of original channel and generates CSI FB for interfering channel (between AP2 and STA1) based on an SVD of equivalent channel.

In some cases, STA1 may provide this (enhanced small V) CSI-FB to AP1. In some cases, STA1 may also provide this CSI-FB directly to AP2. In other cases, AP1 and AP2 may exchange CSI-FB (e.g., if a backhaul exists). For example, AP1 may transmit the CSI-FB for the interfering channel (between AP2 and STA1) to AP2 via a light backhaul. While not shown, STA2 may also generate CSI-FB for its intended channel (between AP2 and STA2) and interfering channel (between AP1 and STA2) and provide this CSI-FB to at least its AP (AP2).

This enhanced CSI processing for small V feedback according to this first sub-option may be described as follows, assuming the i-th AP is the serving AP of the i-th STA so that Hᵢᵢ is an intended channel and all other Hᵢⱼ where j≠i are interfering channels.

For intended channel Hᵢᵢ, STAi may feed back S_{fb,ii}=Sᵢᵢ (1:N_{fb,i}, 1:N_{fb,i}) and V_{fb,ii}=Vᵢᵢ(:, 1:N_{fb,i}) where N_{fb,i}=N_{ss,i}, where N_{ss,i} is the number of streams for the i-th STA that the i-AP intended to send in the CoBFed transmission, assuming using the eigen receiver

$${U}_{ss , ii}^{′}$$

(not fed back) where U_{ss,ii}=Uᵢᵢ(:, 1:N_{ss,i}).

For interfering channel Hᵢⱼ where ≠i, the equivalent channel assuming the Eigen receiver at the i-th STA is

$${U}_{ss , ii}^{′}$$

so that the equivalent channel from the j-th AP to the i-th STA after this Eigne receiver processing becomes

$${U}_{ss , ii}^{′} {H}_{ij} .$$

For the CSI FB for the interfering channel, STAi may perform SVD on the equivalent channel

$${U}_{ss , ii}^{′} {H}_{ij}$$

to obtain:

$${U}_{ss , ii}^{′} {H}_{ij} = {U}_{ss , ij} \cdot {S}_{ss , ij} \cdot {V}_{ss , ij}^{′} ,$$

where U_{ss,ij} is an N_{ss,i}×N_{ss,i} unitary matrix, S_{ss,ij} is an N_{ss,i}×N_{ss,i} diagonal matrix with the singular values of the equivalent channel

$${U}_{ss , ii}^{′} {H}_{ij} ,$$

and V_{ss,i} is an N_{tx,j}×N_{ss,i} semi-unitary matrix. Feedback S_{fb,ij}=S_{ss,ij}(1:N_{fb,i}, 1:N_{fb,i}) and V_{fb,ij}=V_{ss,i}(:, 1:N_{fb,i}) where N_{fb,i}=N_{ss,i}.

A distinction between the enhanced small V feedback according to this first sub-option and typical V feedback is that the enhanced feedback (for the interfering channels) is based on the SVD of the equivalent channel

$${U}_{ss , ii}^{′} {H}_{ij}$$

instead of the SVD of the original channel Hᵢⱼ. In this way, the same receiver

$${U}_{ss , ii}^{′}$$

is assumed for intended and interfering channels. In this example, it is assumed that the Eigen receiver

$${U}_{ss , ii}^{′}$$

is used to generate both the CSI FB for the intended channel Hᵢᵢ and the CSI FB for the interfering equivalent channel

$${U}_{ss , ii}^{′} {H}_{ij} .$$

A more general case in the enhanced feedback is to use a same linear receiver Gᵢ to generate both the CSI FB for the intended equivalent channel GᵢHᵢᵢ and the CSI FB for the interfering equivalent channel GᵢHᵢⱼ.

According to another of the sub-options presented herein, however, STAi may feedback U, S, and V from the SVD of the point-to-point channel. For example, STAi may feed back Uᵢⱼ, Sᵢⱼ and Vᵢⱼ of a requested rank N_{fb,i}, i.e., U_{nfb,ij} (fed back in this case), S_{fb,ij} and V_{fb,ij}.

In some cases, it may be beneficial to exchange certain information that may be needed for joint NDP via NDPA. In some cases, a STA information (info) field may include a special AID value for a shared AP. In some cases, a sounding dialogue token reserved state might be used to signal that this is a NDPA that signals joint sounding. Such an indication may indicate to an AP (and possibly the STAs) that a joint sounding NDP is going to arrive.

In some cases, such information may be conveyed via a single STA info field. Such a field may be considered a special STA Info Field targeted to an AP in NDPA preceding a joint NDP. In some cases, the special STAID per AP can be advertised in the beacon as some form of AP identifier (which may be a self-chosen IP, referred to as a “CoBF special APID). Collisions may be resolved in a similar manner as BSS color collisions. In some cases, the CoBF special APID may be 11 bits.

For CoBF sounding, an NDPA may still being addressed to an in-BSS STA. There may be no need for changes to a BSS ID (transmitter of the NDPA) and STAID in the STA info field to the target STA. Other information may be conveyed, such as the number of streams (columns) being requested in the feedback is Nc. In some cases, a special STA info field may be addressed to a shared AP. This field may convey the starting and ending stream index for the shared AP and may convey information regarding what rows of the P-matrix to use. The STA info field may use a special AID which is associated with the AP.

In some cases, asymmetric CoBF may be supported, for example, with two 4 Tx APs, each having one active STA. Such an example may assume a secondary BSS has a 2Rx STA and secondary AP intends to transmit 1ss to that station. The example may also assume that the primary STA is explicitly sounded to secondary AP channel and that the primary STA pre-calculates the optimum receive filter and pre-compensates the interference channel feedback to the interfering AP (e.g., to provide a single eigen mode where interference needs to be nulled).

Various potential issues related to asymmetric CoBF may be addressed. Such issues may be explained considering an example that assumes a 2Rx STA in the primary BSS. In one case, the STA may be receiving 1ss and feeds back a single Eigen mode to secondary BSS. In such cases, there may be joint LTFs, for which we need pre-negotiation of several things between secondary and primary AP. In another case, the STA may receive 2ss. In such cases, 2 Eigen modes may be fed back to the secondary BSS AP.

There are various options for CoBF group formation, in order to determine what APs will participate in CoBF). According to a first option, a sharing AP (e.g., AP1) sends a CoBF opportunity trigger to the APs, an intent to participate, and a final CoBF configuration. The trigger may contain a number of spatial multiplexing dimensions available at sharing AP, a list of APs that AP1 is inviting for CoBF (AP1 sees them as good CoBF candidates). For example, some STAs in BSS1 may get labeled via a background process as good candidates for CoBF with AP2 and AP3. A trigger may also indicate resources for transmitting an intent to participate. The intent to participate (transmitted using TB PPDU) may contain a number of spatial multiplexing dimensions (or number of antennas) available at shared AP and indicate to a responding AP (e.g., AP2 and AP3) STAs which are good candidates for CoBF with AP1. The final CoBF configuration may contain an identifier for the AP (s) in 2-AP groups as shared AP (s) for CoBF with sharing AP1.

According to another option for CoBF group formation, every AP may advertise various information in the beacon. Such information may include, for example, spatial multiplexing capability (maybe equal to the number of antennas) for CoBF and a list of good candidate neighboring APs for CoBF. In some cases, this list may get updated in the beacon based on the in-BSS background process. In some cases, there may be no explicit group formation phase. Rather group formation may begin directly with the sounding phase with one AP acting as sharing AP.

There are various options for resolving collisions of CoBF APID with STAID in the first option described above. For example, if AP2 picks a CoBF APID which matches STA1's ID, various information may be signaled in the NDPA. Such information may include, for example, that the NDP is a UHR variant of NDP and/or is a joint sounding NDP (e.g., via reserved state in sounding dialogue token). Such information may notify the STA1 and AP2 that there is a STA info field that is meant for AP2 at a fixed location (e.g., either the first or the last STA info field in the NDPA). In some cases, the STA may ignore that STA info field even if the STAID matches.

In some cases, such signaling may also be used by AP2, for example, to determine that an NDPA is a special NDPA, which prompts AP2 to send an NDP in response. The signaling may also notify AP2 that it needs to look for a special STA info field at either the beginning or the end.

### Capability Element Design for Optional Wireless Features

As noted above, a variety of different features may be optional in various wireless communications standards. Examples of such features involve support for certain low density parity check (LDPC) codeword (CW) sizes, support for certain modulation and coding schemes (MCSs), support for unequal modulation (UEQM) with different modulation orders across different streams in a same packet. Other examples of optional features involve support of distributed resource units (RUs), extended long range (ELR) PPDU support, coordinated beamforming (CoBF), coordinated spatial reuse (CSR), and support for an interference mitigation mechanism (IMM).

These certain features may not be mandatory for a given wireless communication standard, in the sense that a device may be considered compliant with that standard without having to support these features. A device may choose to enable or disable such features for various reasons, such as improved performance, reduced interference, or reduced power consumption.

As a result, APs and STAs typically need to exchange capability information to determine what features will be supported for a given communication session. Unfortunately, the exchange of capability information comes at a cost of signaling overhead. As noted above, certain optional features may also have various subcomponents, support of which may need to be indicated.

Aspects of the present disclosure provide various mechanisms for signaling support for features considered optional for a wireless communications session. For example, such features may be considered optional, but not mandatory, for a wireless communications standard.

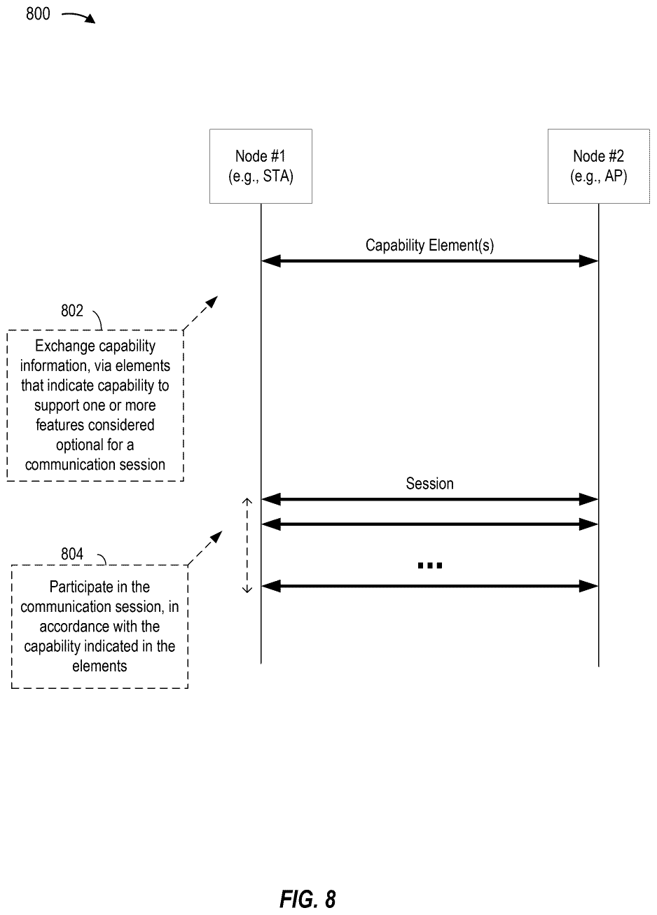

The signaling mechanisms proposed herein may be understood with reference to call flow diagram 800 of FIG. 8.

In some aspects, the first wireless node (Node #1) shown in FIG. 8 may be an example of a (non-AP) STA 104 depicted and described with respect to FIG. 1. In some aspects, the second wireless node (Node #2) shown in FIG. 8 may be an example of an AP 102 (an AP STA) depicted and described with respect to FIG. 1.

As illustrated at 802, the first and second wireless nodes may exchange capability information, via elements that indicate capability to support one or more features considered optional for a communication session. As will be described in greater detail below, the elements may be capability elements included in one or more frames.

As illustrated at 804, the first and second wireless nodes may then participate in the communication session, in accordance with the capability indicated in the elements. For example, the first and second wireless node may participate in the communication session using one or more advanced features indicated in the exchange of capability elements.

In general, mandatory features do not need additional signaling to determine capability. Support of optional features, on the other hand, may be assumed (by default) to be not supported if not explicitly signaled through capabilities element. As an example, an AP may support a new optional (e.g., optional in 802.11bn) feature for use in DL transmission. However, the feature may also be optional at the STAs (for DL reception). Before the AP can use the feature in a DL transmission, it may need to know whether the intended STA of that transmission supports the reception of transmissions using that new feature. This may be accomplished prior to the AP transmission, for example, through some capability exchange procedure as illustrated in FIG. 8 (which can be initiated by either the STA or AP).

Capability information may be exchanged in fields and subfields of capability elements (e.g., 802.1111be EHT) physical (PHY) capability elements. Such capability elements may convey a bit vector with bit positions defined to carry capability information (and relevant parameters) for various PHY features and functions.

Capabilities elements may be present in various types of frames, such as association request and response frames, re-association request and response frames, probe request and response frames, and beacons (e.g., from APs). In some cases, a capability element may pertain (apply) to a current band and channel that it was sent/received in. In some cases, if a STA or AP changes channels, it may be assumed that all optional features/modes are not supported, until a subsequent capability element exchange re-establishes optional features support.

This may be understood by considering an example in which a STA, while operating in 2.4 GHz Channel 1, sends a capability element to the AP which indicates support for an optional feature. At a later time, the STA moves to Channel 2 in the 2.4 GHz band. In Channel 2, the AP may make no assumptions regarding continued support for any of the optional features, until it receives a capability element from that STA (which will explicitly indicate which optional features are supported for this channel).

Another example assumes a STA is simultaneously operating in 2.4 GHz and 5 GHz with an AP (e.g. Multi-link Operation). The STA's supported optional features in 2.4 GHz may be signaled through a Capability Element sent to the AP in 2.4 GHz. Similarly, the STA's supported optional features in 5 GHz will be through a Capability Element sent to the AP in 5 GHz.

Another example assumes an AP is operating in 2.4 GHz and 5 GHz (e.g. dual band simultaneous-DBS). The AP's supported optional features for 2.4 GHz and 5 GHz may be signaled separately through capability elements sent to the respective STAs associated with it in 2.4 GHz and 5 GHz.

In some cases, capability elements may indicate support of at least one low density parity check (LDPC) codeword size.

For example, a wireless standard may introduce a new codeword size for LDPC, such as 2×1944 bits, with a new generation matrix for each of the LDPC Rates (1/2, 2/3, 3/4, 5/6) to produce that codeword size. A 2×1944 codeword size (3888 bits) may be referred to herein as “2×LDPC” as it is twice as large as previous largest supported size of 1944).

In some wireless standards (e.g., 802.11 be), LDPC support may mean being capable of Tx and Rx of LDPC for all previous codeword sizes (e.g., 648, 1296, 1944 bits), for all valid MCSs. For any LDPC scenario, once mutual capability between Tx and Rx is established, actual rules for usage may be defined in the LDPC encoding section of the wireless standard (e.g. an 802.11 standard specification). A field in a capability element may be designed to be able to indicate support for 2×LDPC, with possibly some amount of granularity across different LDPC Rates.

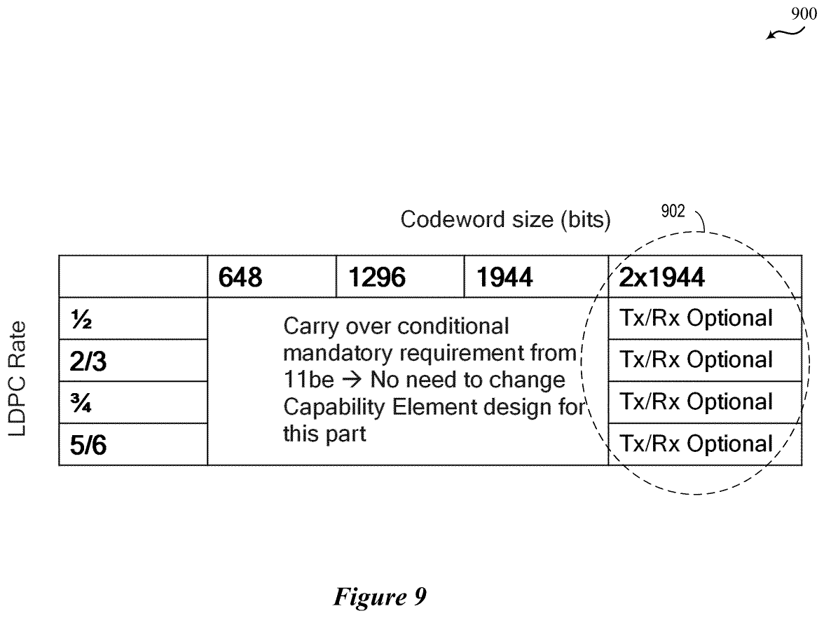

As illustrated at 902 in table 900 of FIG. 9, in some cases, support for 2×LDPC (2×1944) may be divided into separate Tx and Rx support. A capability element field, as shown in FIG. 9, may allow a device to selectively support (Tx and Rx) 2×LDPC across different LDPC rates (e.g., 1/2, 2/3, 3/4, and 5/6). Separate capabilities for Tx and Rx may be supported, for example, since implementation burdens and costs for LDPC encoding (Tx) and decoding (Rx) can be different.

FIG. 10 illustrates an example element 1000 that supports separate indications (for Tx and Rx support) in a 2×LDPC field for support for different LDPC rates. In some cases a standard (e.g., UHR) may inherit LDPC Tx/Rx support (e.g., up to a previously supported 1×1944 codeword size) from an HE Capability Element field indication.

As indicated in table 1050, for Tx and Rx subfields, a bit-map may indicate 2×1944 codeword support for each LDPC coding rate. In the illustrated example, a 4-bit bitmap indicates support for the transmission/reception of the 2×1944 codeword size when using LDPC. Each bit-position may corresponds to an LDPC code rate, for example, where a bit is set to 0 to indicate that rate is not supported or to a 1 to indicate the rate is supported. Thus, these bits may be set to all 0's to indicate LDPC Tx/Rx is not supported.

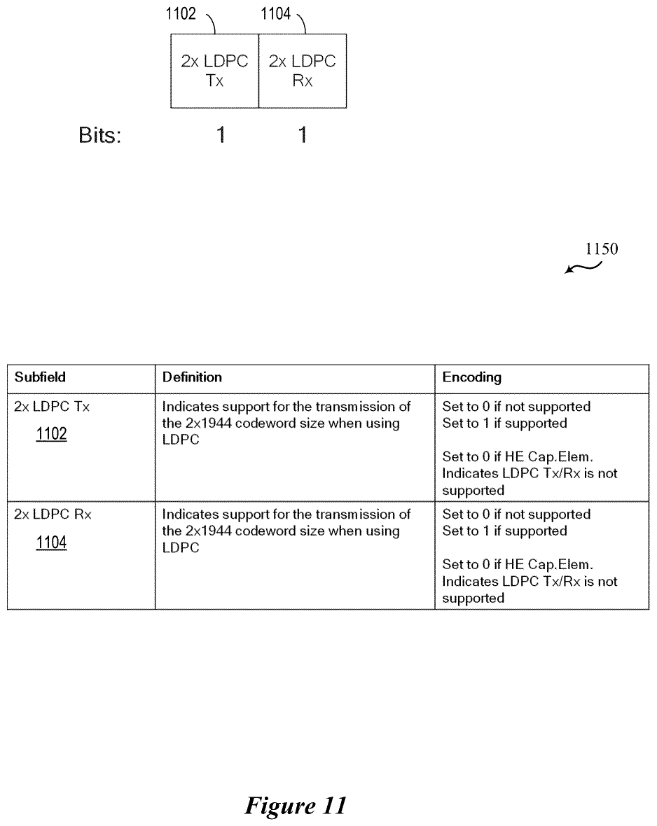

FIG. 11 illustrates another example element that uses a single bit (1102 for Tx and 1104 Rx) to indicate support for 2×LDPC across all LDPC rates. As indicated in table 1150, the 1-bit fields 1102 and 1104 may be set to a 0 to indicate that 2×LDPC is not supported (for Tx and Rx, respectively) for any rate or to a 1 to indicate that 2×LDPC is supported across all rates.

In this manner, UHR may inherit LDPC Tx/Rx support (up to 1×1944 codeword size) from HE Capability Element field indication with the 1-bit fields for a UHR Capability Element being specific to a new (e.g., 2×1944) codeword size.

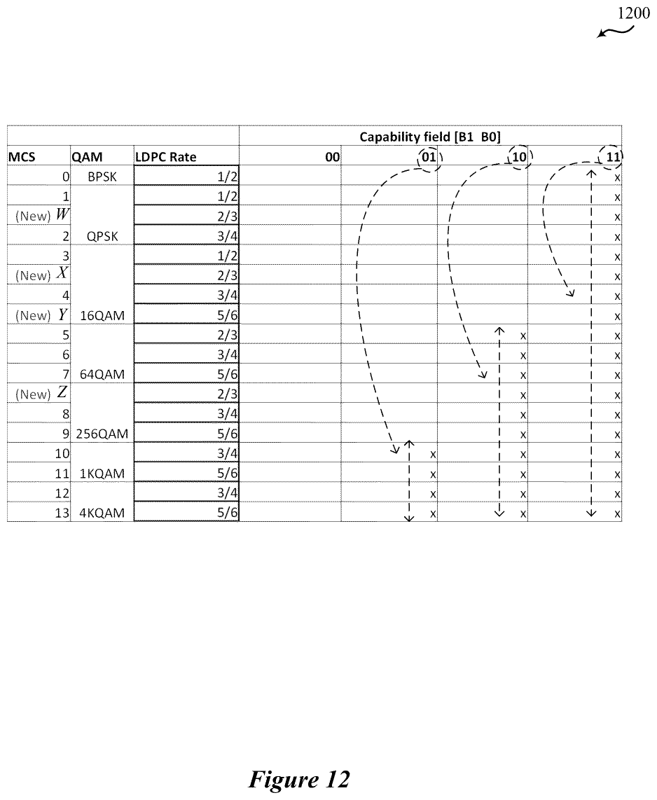

Table 1200 of FIG. 12 illustrates an alternative to specifying support per LDPC rate, using MCS levels as boundaries for support signaling. This signaling mechanism may help support rate adaptation, which traverses MCS, by indicating support for certain LDPC codeword sizes (e.g., whether an MCS is supported for 2×LDPC CW size).

As indicated in table 1200, bits in a capability field may indicate a range of MCSs for which 2×LDPC is supported. In some cases, this approach may allow a device the option to choose to only support the 2×LDPC definitions (among the rates) needed to use for some MCS value and higher.

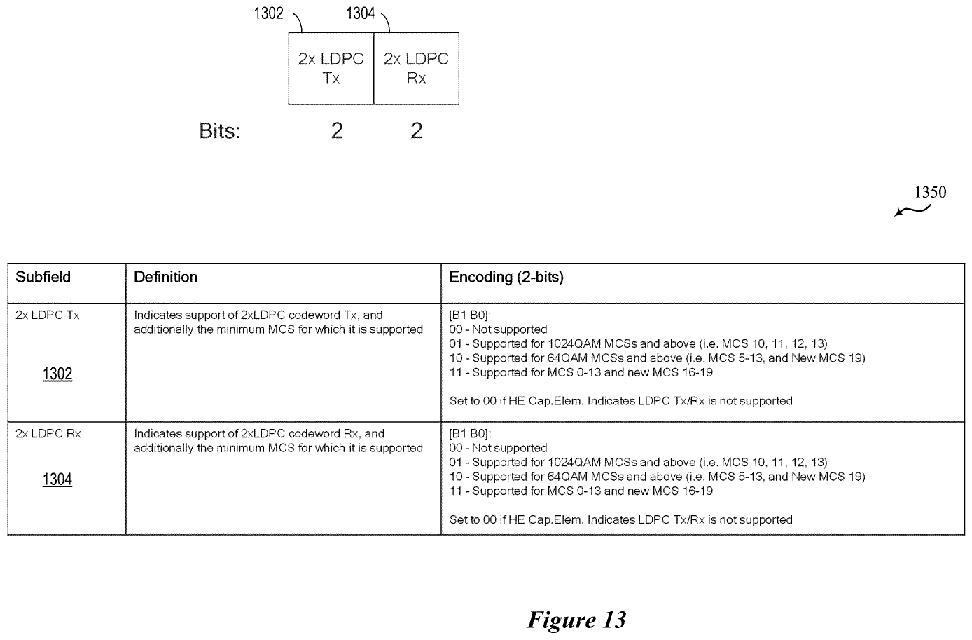

In the illustrated example, a 2-bit field ([B1 B0]) indicates no 2×LDPC support for any MCS if set to 00, support for a first range of MCSs (13-10) if set to 01, support for a second range of MCSs (13-5 including a new MCS Z) if set to 10, or support for a third range of MCSs (13-0, including new MCSs W, X, Y, and Z) if set to 11). Support for potential new MCSs W, X, Y, and Z are described in greater detail below. As illustrated in field 1300 and table 1350 of FIG. 13, such a 2-bit field may be provided so a device can indicate separate such indications for Rx and Tx.

In general, this approach may be used to define minimum MCS index (or alternatively minimum QAM order) boundaries, for which 2×LDPC support can be signaled. The table in FIG. 12 shows possible boundaries for a 2-bit encoding, but the idea also applies to options with more bits, in which case more possible boundaries can be encoded.

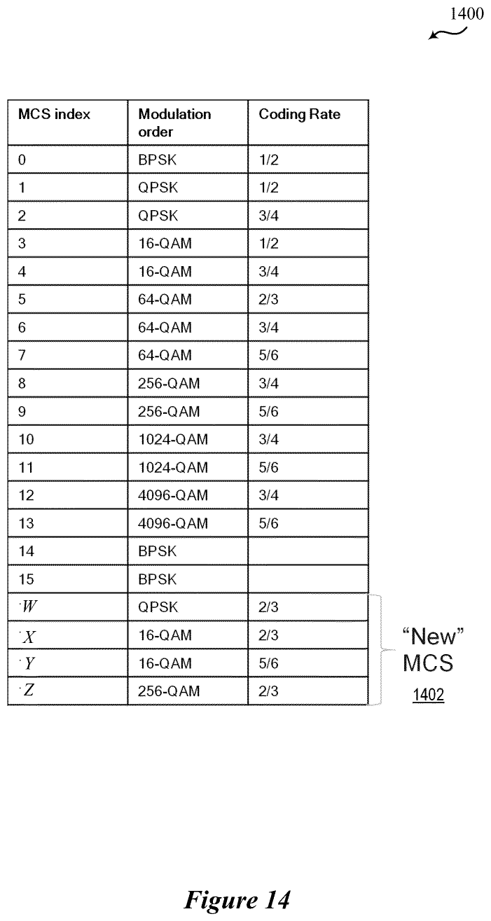

In some cases, capability elements may indicate support of at least one or more (new) MCSs. For example, at 1402 in table 1400 of FIG. 14, a set of new MCSs labeled W, X, Y, and Z is shown. If the current MCS indices are extended, these new MCSs could correspond to indices 16-19. However, as indicated in FIG. 12, the data rates of the new MCSs may actually slot between existing MCS data rates (e.g., with W between MCS 1 and MCS 2), so other more suitable index values (indices) may be used.

Support for new MCSs may be expected to be mandatory for all devices (both Tx and Rx) in some cases. However, in certain scenarios (e.g., via 802.11be) MCSs may be grouped into sets and, for each MCS group, a maximum quantity of spatial streams (Nss) supportable may be defined and indicated.

In some cases, a device may have separated Nss capabilities for Tx and Rx. Further, depending on operating scenario (e.g., device type, bandwidth capability, and Nss being used) a maximum QAM order could be either 64-QAM, 256-QAM, 1024-QAM, or 4096-QAM. The maximum QAM order may dictate what new MCS indexes should be supported. For example, for UHR, if a device operating scenario has a maximum QAM order of: 1) 64-QAM, then New MCS indexes 16, 17, 18 may be expected to be supported; and 2) 256-QAM or higher, then all New MCS indexes (16, 17, 18, 19) may be supported.

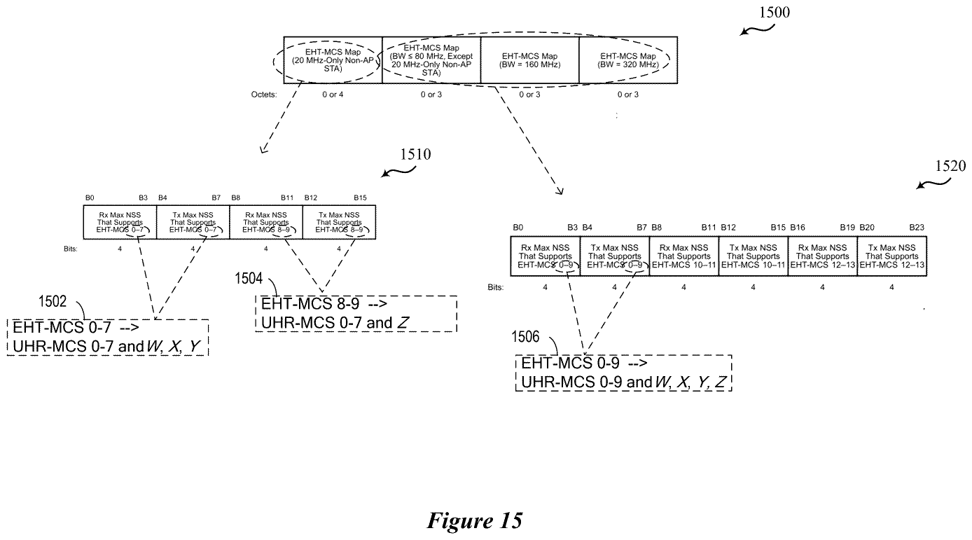

As illustrated in FIG. 15, “Supported UHR-MCS and NSS Set” field definitions of UHR Capabilities element may be modified to accommodate these new MCSs. For example, if new MCSs become mandatory, the UHR-MCS Map element definition will have to be modified, as shown at 1502, 1504, and 1506 from:
EHT-MCS 0-7→UHR-MCS 0-7 and W, X, Y;
EHT-MCS 8-9→UHR-MCS 8-9 and Z; and
EHT-MCS 0-9→UHR-MCS 0-9 and W, X, Y, Z.

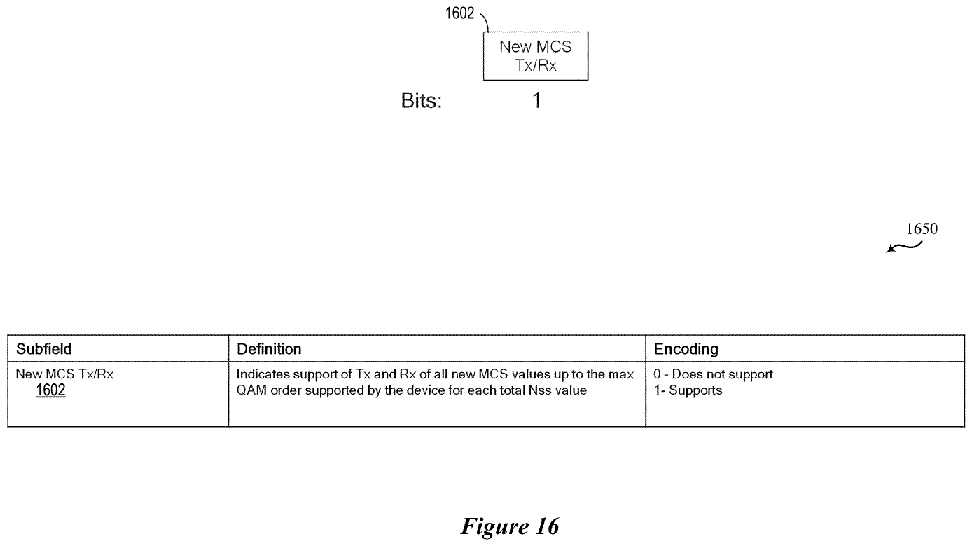

According to certain aspects, as shown in FIG. 16, if optional, a capability element field for new MCS support may be defined with 1-bit 1602. As indicated in table 1650, the new MCS Tx/Rx bit 1602 may indicate support of Tx and Rx of all new MCS values up to the maximum QAM order supported by the device for each total Nss value (e.g., with a 0 indicating no support and a 1 indicating support).

In some cases, capability elements may indicate support for unequal modulation (UEQM), meaning support for different modulation used across different streams in a same packet.

In some cases, UEQM-SS may be an optional feature. Both UEQM and EQM (equal modulation MIMO) may be considered forms of Tx beamforming (BF), so some common capability parameter signaling (such as max Nss supported) may be shared (e.g., UEQM signaling may inherit from existing EQM signaling). For Tx and Rx, a maximum Nss for UEQM may be 4, so a device supporting UEQM would support min(4, Nss,eqm), where Nss,eqm represents the maximum number of spatial streams supported in EQM. The UEQM feature may apply to both APs and STAs, meaning both can be the Tx beamformer (TxBFer) and/or the Tx beamformee (TxBFee).

There are options in how to signal device capability regarding UEQM support. For example, one option is, if a device supports UEQM, that device should be expected to support all unequal stream patterns for each Nss level, up to the maximum Nss supported by that device for UEQM.

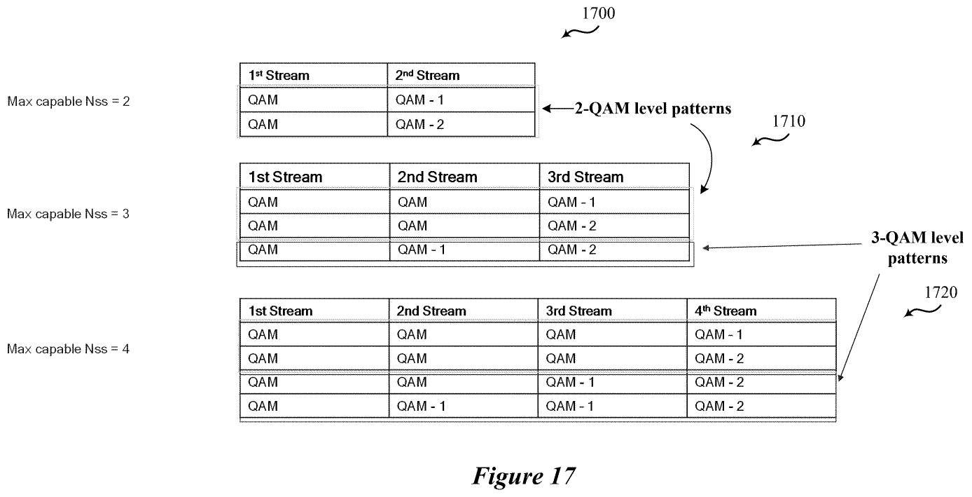

As illustrated in FIG. 17, current standards device different QAM variation patterns for UEQM for a device capable of up to Nss. Patterns for a device with maximum capable Nss=2, are 2-QAM level patterns (e.g., with two different QAM levels in a patter) as shown at 1700. Patterns for a device with maximum capable Nss=3, are 2-QAM and 3-QAM level patterns (e.g., with 3 different QAM levels in a pattern) as shown at 1710. Patterns for a device with maximum capable Nss=4, are also 2-QAM level and 3-QAM level patterns as shown at 1720.

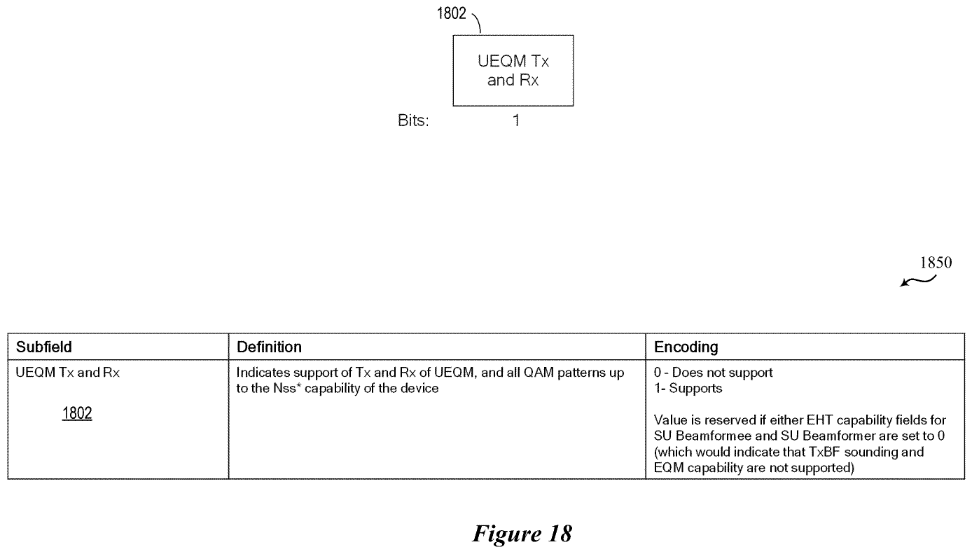

According to certain aspects, as shown in FIG. 18, a capability element field may include a 1-bit field 1802. As indicated in table 1850, the bit 1802 may indicate UEQM support of Tx and Rx for all QAM patterns (e.g., up to the Nss* capability of the device). As indicated, a value of 0 may indicate no support, while a value of 1 may indicate support. In some cases, a value of this bit may be reserved, for example, if either EHT capability fields for SU Beamformee and SU Beamformer are set to 0 (which would indicate that TxBF sounding and EQM capability are not supported).

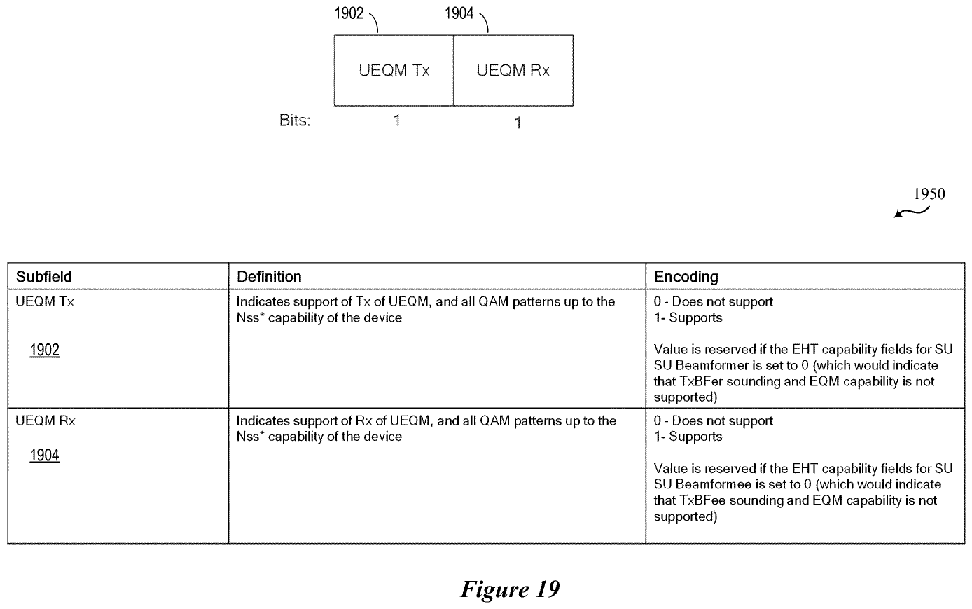

A variation, as shown in FIG. 19, is for a capability element field with 2 bits 1902 and 1904. As indicated in table 1950, bit 1902 may indicate UEQM support of Tx for all QAM patterns (e.g., up to the Nss* capability of the device), while the bit 1904 may indicate UEQM support of Rx for all QAM patterns (e.g., up to the Nss* capability of the device). As indicated, a value of 0 may indicate no support, while a value of 1 may indicate support. As noted above, a value of this bit may be reserved, for example, if either EHT capability fields for SU Beamformee and SU Beamformer are set to 0 (which would indicate that TxBF sounding and EQM capability are not supported).

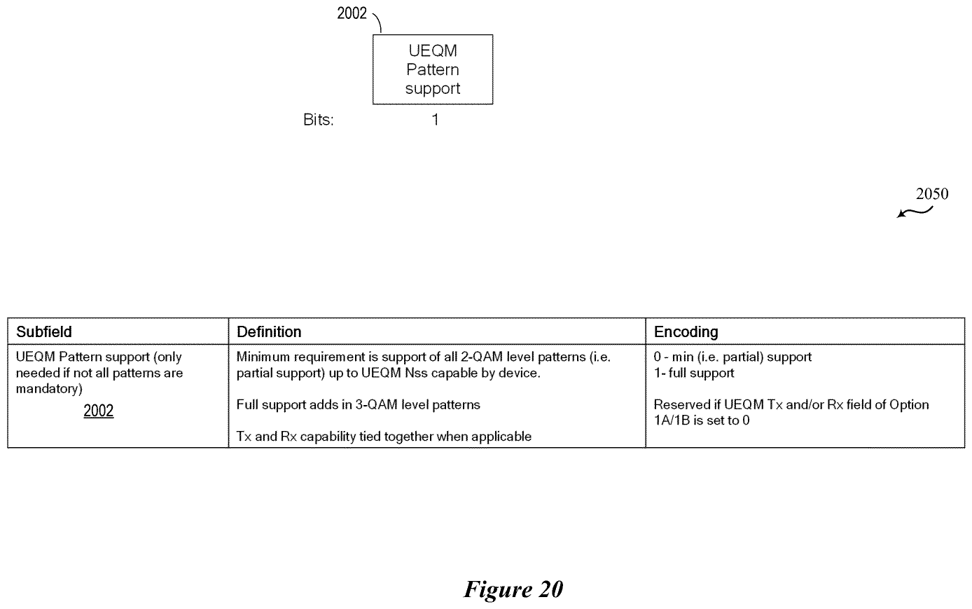

Another variation, as shown FIG. 20, is to indicate support for a subset of patterns. According to this option, a device may indicate general support for UEQM (e.g., in one of the manners described above). Additionally, via a bit 2002, the device may indicate general (full) or partial support for UEQM. As indicated in table 2050, partial support may be for a subset of defined QAM patterns.

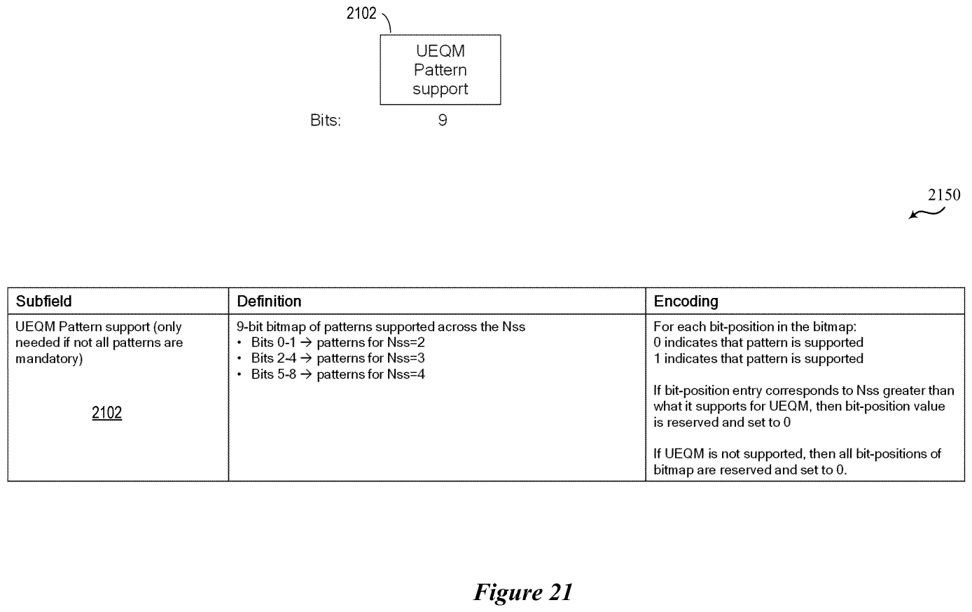

Another variation, as shown FIG. 21, is to indicate support of a subset of patterns via a bitmap 2102. Such an approach may be needed, for example, if support for all patterns is not mandatory. As indicated in table 2150, the bitmap may individually indicate support for each pattern within each SS (e.g., as shown in FIG. 17). In the illustrated example, a 9-bit bitmap of patterns supported across the Nss, as follows:
Bits 0-1→patterns for Nss=2;
Bits 2-4→patterns for Nss=3; and
Bits 5-8→patterns for Nss=4.

For each bit-position in the bitmap, a 0 indicates that a corresponding pattern is not supported, while a 1 indicates that pattern is supported. If bit-position entry corresponds to an Nss greater than what it supports for UEQM, then this bit-position value may be reserved and set to 0. Similarly, If UEQM is not supported, then all bit-positions of bitmap are reserved and set to 0.

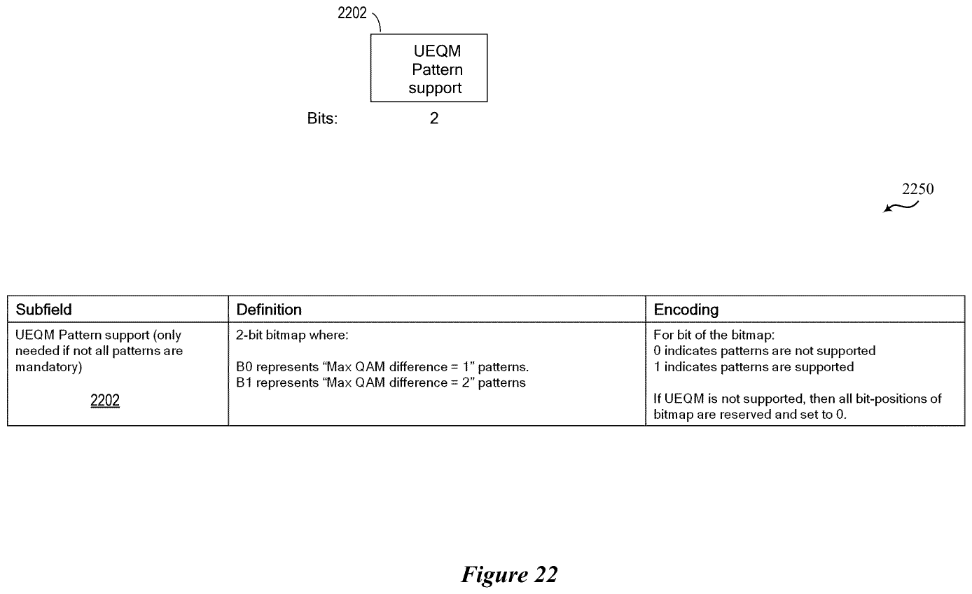

Another variation, as shown FIG. 22, is to indicate support of a subset of patterns via a bitmap 2202 by indicating a maximum QAM difference a device supports in a pattern. As indicated in table 2250, with a 2-bit example, the bits may indicate support for patterns with a maximum QAM difference of 1 or support for patterns with a maximum QAM difference of 2. As an example, the maximum QAM difference in the Nss=3 [QAM, QAM-1, QAM-2] pattern shown in table 1710 of FIG. 17 would be 2. For each bit-position in the bitmap, a 0 indicates that a corresponding QAM difference is not supported, while a 1 indicates that corresponding QAM difference is supported. As in the examples above, if UEQM is not supported, then all bit-positions of bitmap are reserved and set to 0.

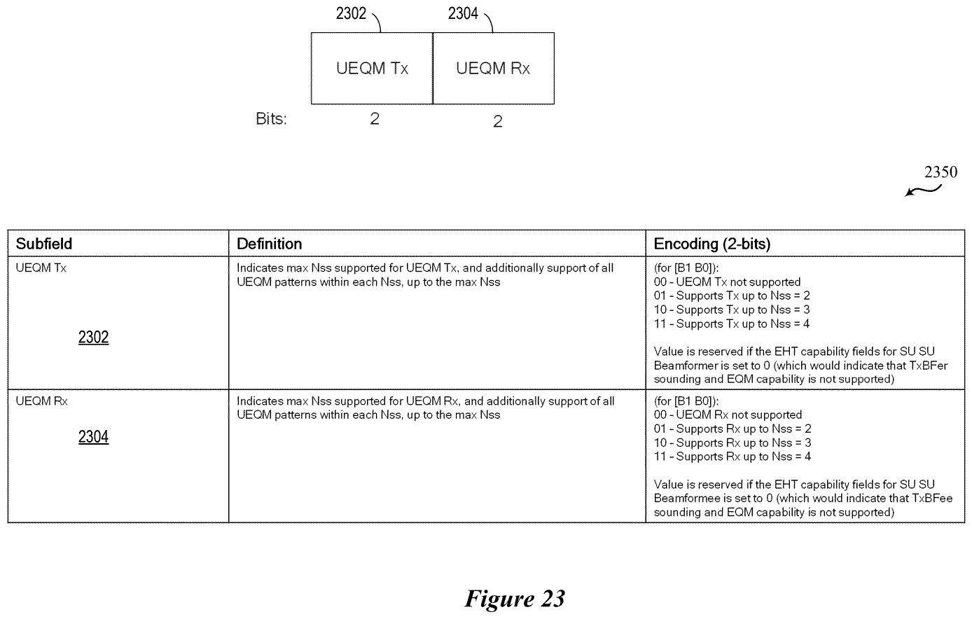

Another variation, as shown FIG. 23, is to indicate a maximum Nss supported for Tx (via bits 2302) and Rx (via bits 2304) that the device supports for UEQM. This approach assumes the device supports all defined UEQM patterns within each Nss, up to the maximum Nss indicated. As indicated in table 2350, assuming two bits, the following support may be indicated for Tx/Rx via bits 2302/2304 as follows:
00—UEQM Tx/Rx not supported;
01—Supports Tx up to Nss=2;
10—Supports Tx up to Nss=3; and
11—Supports Tx up to Nss=4.
   The value may be reserved if the EHT capability fields for SU Beamformer is set to 0 (which would indicate that TxBFer sounding and EQM capability is not supported).

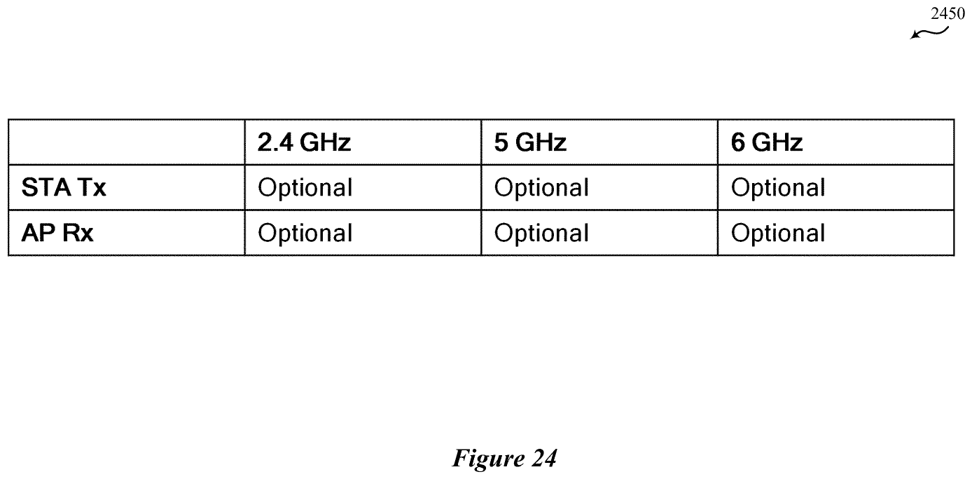

In some cases, capability elements may indicate support for distributed resource units (dRUs). With dRU, RUs may be distributed across wider bandwidth when compared to regular RUs (rRUs), which may provide flexibility and higher transmit power per tone. DRU may only be used for UL TB PPDUs. As indicated in table 2450 of FIG. 24, DRU may be considered an optional feature for Tx and Rx, across all frequency ranges. Aspects of the present disclosure provide mechanisms for how to indicate support for certain distribution bandwidths.

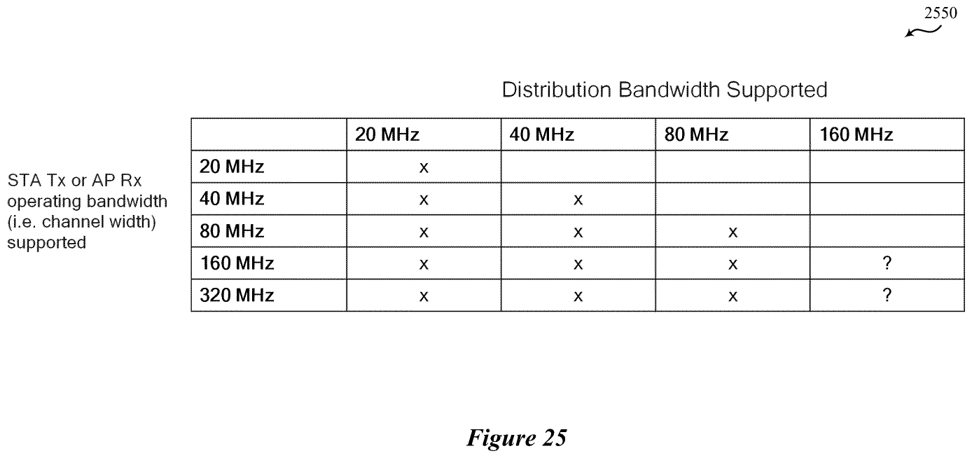

For example, in some cases, as indicated in table 2550 of FIG. 25, 160 MHz distribution BW may be an optional sub-feature within an overall DRU feature (e.g., in cases where 160 MHz dBW is included). In some cases, an additional bit may be allocated in a “DRU field” of a Capabilities element for indicating support of specifically 160 MHz Tx/Rx. In cases where 160 MHz dBW is not included, then this additional field would not need to be present in Capability element. In some cases, within a supported distribution BW, it may be expected that all dRU tone sizes will be supported.

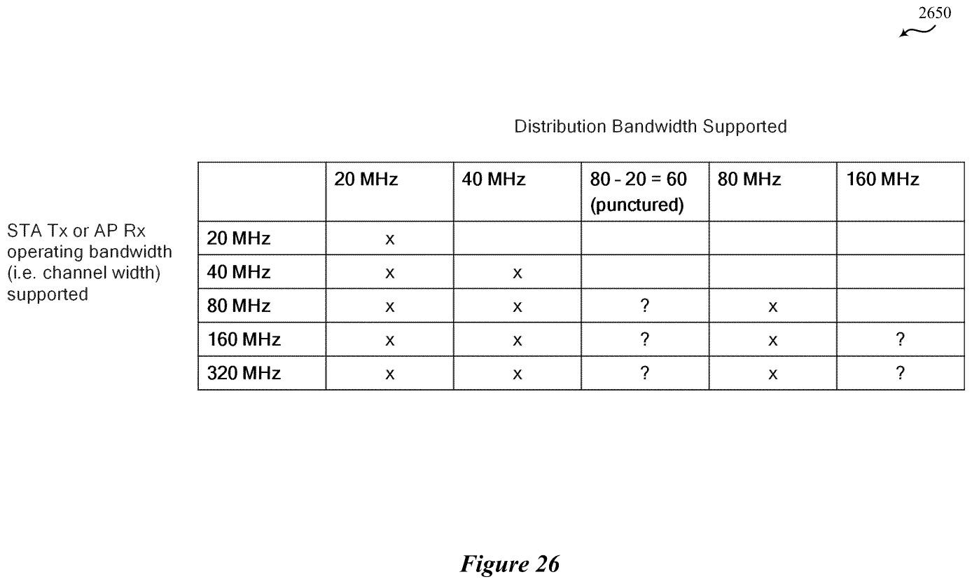

In some cases, dRU may be supported in punctured distribution bandwidth. As an example illustrated in table 2650 of FIG. 26, a 60 MHz punctured distribution bandwidth may result from puncturing 20 MHz from 80 MHz. In some cases, support for 80−20=60 MHz punctured distribution bandwidth may be indicated by a separate capability sub-field, for example a 1-bit field called “DRU Punc. BW support.”

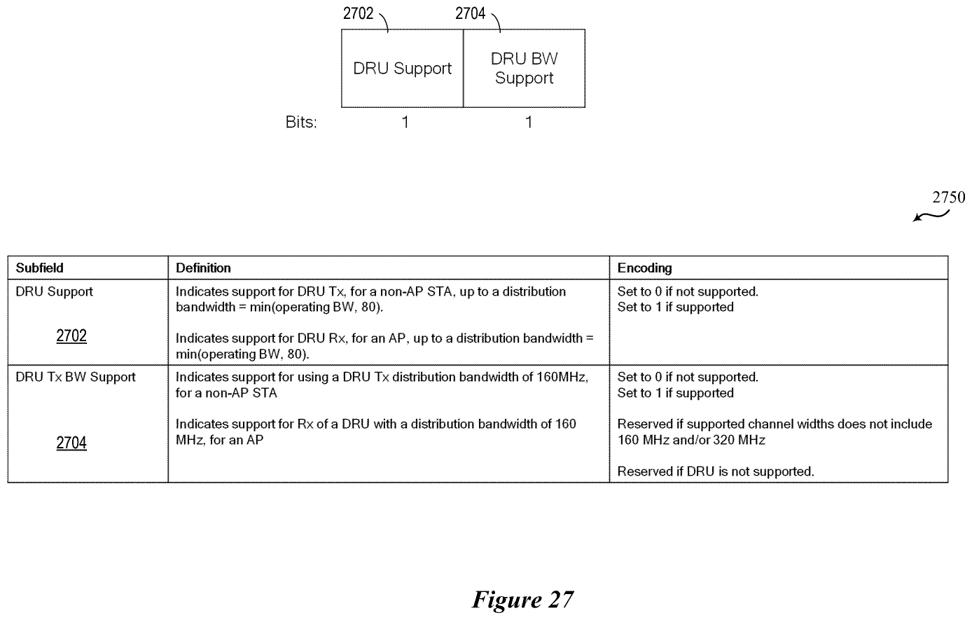

As indicated in FIG. 27, in some cases a first bit 2702 may indicates support for DRU Tx (e.g., indicated with “Xs” in FIG. 26), for a non-AP STA, up to a distribution bandwidth, for example, min(operating BW, 80). This bit may also indicate support for DRU Rx, for an AP, up to the distribution bandwidth. A second bit 2704 may indicate support for using a DRU Tx distribution bandwidth of 160 MHz (e.g., indicated with “?s” in FIG. 27, for a non-AP STA. This bit may also indicate support for Rx of a DRU with a distribution bandwidth of 160 MHz, for an AP.

In addition to previous sub-features described above (160 MHz distribution bandwidth, 80−20=60 MHz punctured distribution bandwidth), a device may support a hybrid mode where regular RUs and dRUs are simultaneous used. This hybrid DRU+RRU operation mode may be an additional optional sub-feature.

In some cases, hybrid mode PPDUs may be defined for PPDU bandwidths of 160 MHz and above. Within the PPDU bandwidth, a 80 MHz subchannel may be designated either an RRU or DRU subchannel. In some cases, the minimum spreading bandwidth for a DRU in a PPDU bandwidth may be 80 MHz (e.g., the minimum RRU subchannel width). RRUs may be contained within RRU subchannels only (e.g., with no mixing with DRUs).

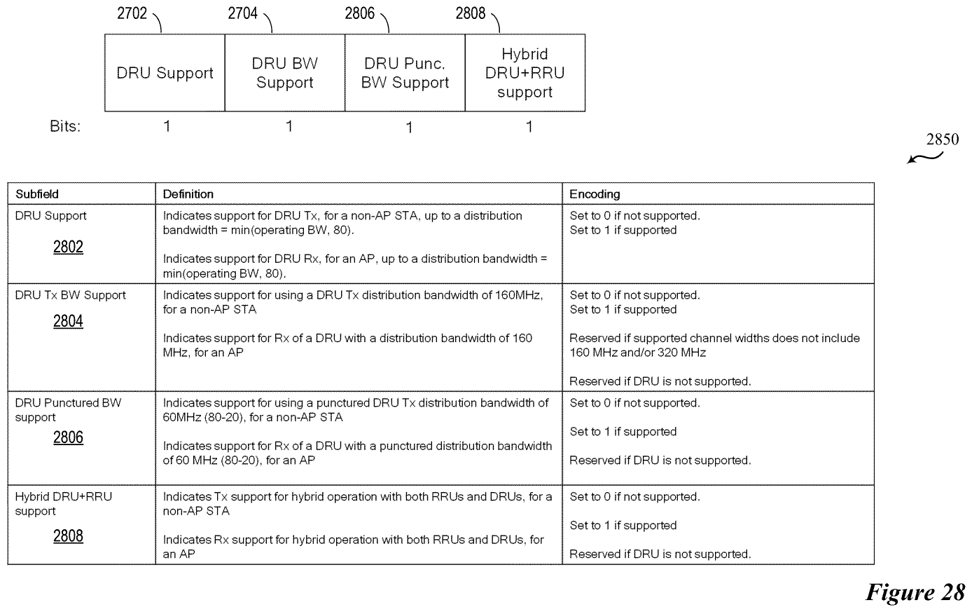

As illustrated in FIG. 28, in some cases, an additional 1-bit sub-field 2808 may be used to signal support or non-support of this hybrid DRU+RRU mode. As indicated in table 2850, bits 2702 and 2704 may indicated DRU support and DRW BW support, as described above with reference to FIG. 27.

As indicated, DRU Punctured BW support bit 2806 may indicate support for using a punctured DRU Tx distribution bandwidth of 60 MHz (80-20), for a non-AP STA. This bit may also indicate support for Rx of a DRU with a punctured distribution bandwidth of 60 MHz (80-20), for an AP. Hybrid DRU+RRU support bit 2808 may indicate Tx support for hybrid operation with both RRUs and DRUs, for a non-AP STA, and Rx support for hybrid operation with both RRUs and DRUs, for an AP.

In some cases, capability elements may indicate support for an extended long range (ELR) feature. ELR generally refers to enhancements that allow for greater communication distances. ELR may be particularly helpful in applications requiring long-range connectivity, such as in rural or expansive environments.

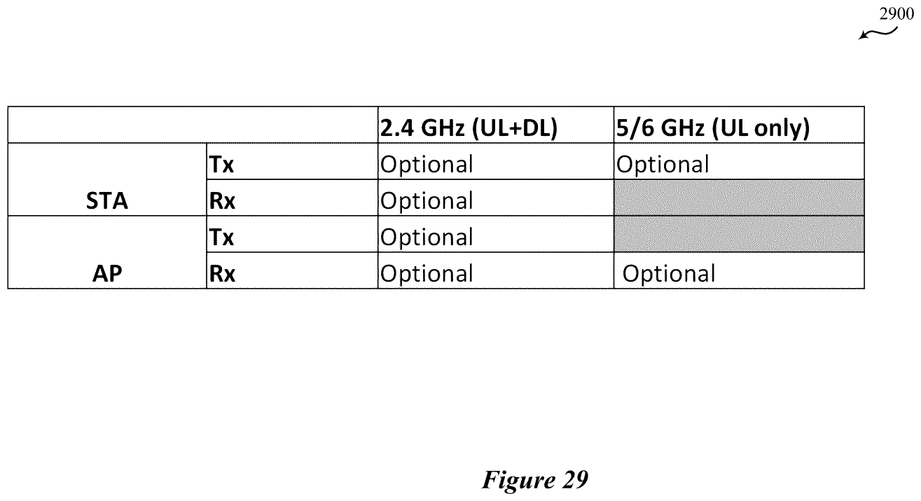

As indicated in table 2900 of FIG. 29, ELR may be supported differently on different operating bands. For example, in the 2.4 GHz band, ELR PPDU may be used for DL and UL while for 5/6 GHz bands, ELR PPDU may be used on UL only.

Aspects of the present disclosure provide mechanisms for signaling ELR as an optional feature. In some cases, ELR support may be indicated separately for Tx and Rx. For example, for Tx, carrier frequency offset (CFO) pre-correction may be applied as an ELR feature.

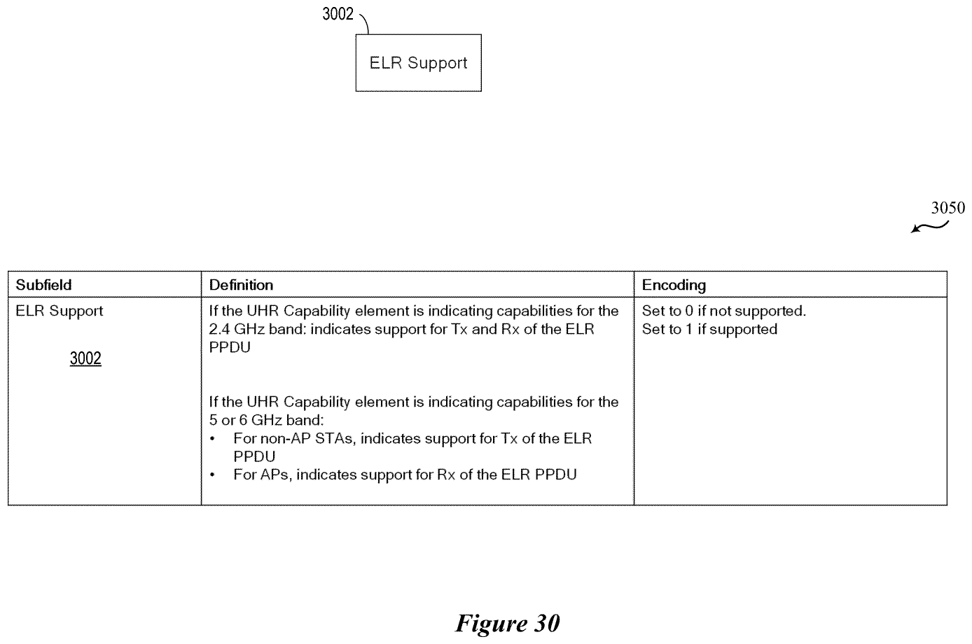

As illustrated in FIG. 30, however, if ELR support for Tx and Rx is tied together, then 1-bit 3002 can be used to signal support/non-support of ELR in the Capability element. As indicated in table 3050, if the UHR Capability element is indicating capabilities for the 2.4 GHz band, bit 3002 may indicate support for Tx and Rx of the ELR PPDU. If the UHR Capability element is indicating capabilities for the 5 or 6 GHz band, for non-AP STAs, bit 3002 may indicate support for Tx of the ELR PPDU and, for APs, bit 3002 may indicate support for Rx of the ELR PPDU.

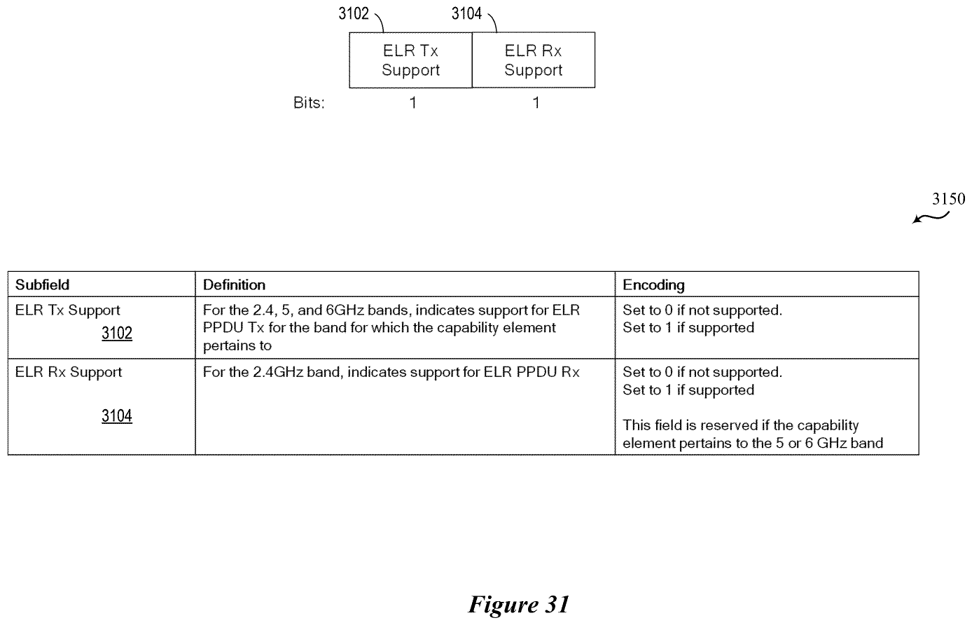

Alternatively, as shown in FIG. 31, 2-bits 3102 and 3104 may be used to signal ELR support for Tx and Rx capability separately. As indicated in table 3150, bit 3102 may be used to indicate, for the 2.4, 5, and 6 GHz bands, support for ELR PPDU Tx for the band for which the capability element pertains to. Bit 3104 may be used to indicate, for the 2.4 GHz band, support for ELR PPDU Rx.

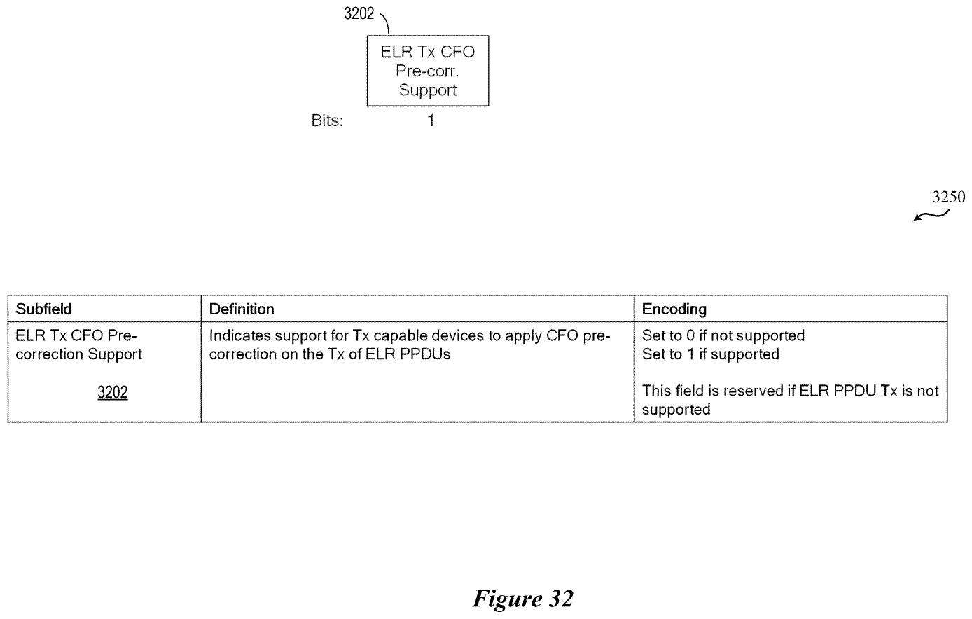

As shown in FIG. 32, in some cases a bit 3202 may be used to indicate support for Tx CFO pre-correction. Devices will typically implement autocorrelation or cross-correlation based detectors at the Rx to search for STF of incoming ELR PPDUs. Cross-correlation approaches may be susceptible to carrier frequency offset between the Tx and Rx. As indicated in table 3250, bit 3202 may be used to indicate support for Tx capable devices to apply CFO pre-correction on the Tx of ELR PPDUs.

Aspects of the present disclosure provide mechanisms for signaling CoBF as an optional feature. In some cases, there may be limits on CoBF, such as applying on DL only, limiting the number of participating APs to 2, limiting the number of STAs to 4 total (2 per AP). Coordinated beamforming will be optional feature for both AP Tx and STA Rx.

Aspects of the present disclosure provide mechanisms for signaling support for various CoBF features, such as Joint sounding and/or Sequential sounding, STA parameters that need to be known at AP, a number of LTFs (e.g., in joint NDP) that a STA can support, a number of Rx antennas at the STA, and partial bandwidth operation.

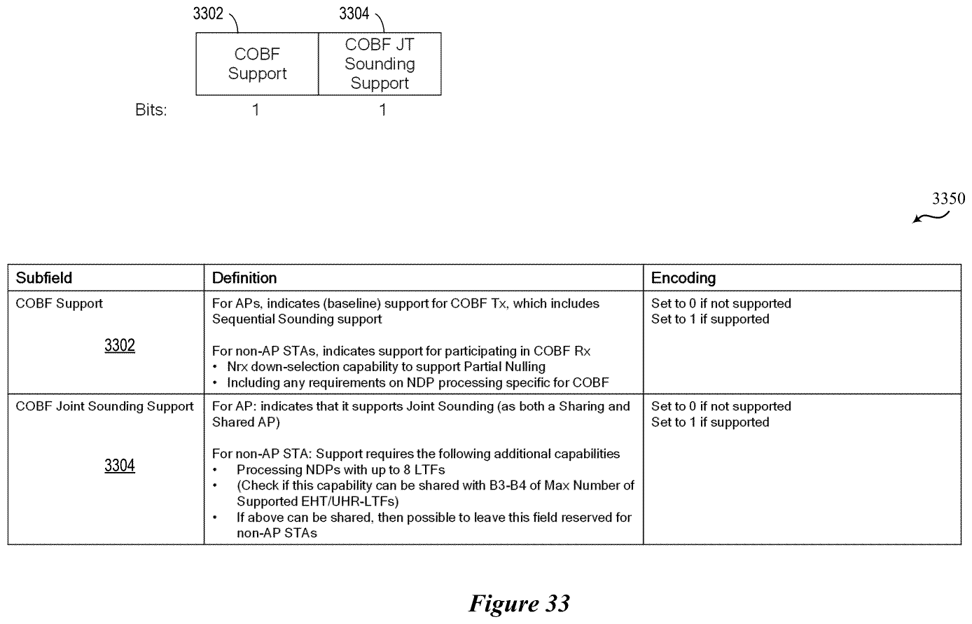

As illustrated in FIG. 33, 2-bits 3302 and 3304 may be used to signal CoBF support and COBF joint sounding support, respectively. As indicated in table 3350, bit 3302 may be used to indicate, for APs, (baseline) support for COBF Tx (e.g., which may include Sequential Sounding support). For non-AP STAs, this bit may also indicate support for participating in COBF Rx and a number of receive antennas (Nrx) down-selection capability to support Partial Nulling, including any requirements on NDP processing specific for COBF. Bit 3304 may be used to indicate, for an AP, that it supports Joint Sounding (e.g., as both a Sharing and Shared AP). For a non-AP STA, support may also involve various additional capabilities. The additional capabilities may include, for example, processing NDPs with up to 8 LTFs. In some cases, this capability may be signaled via certain bits (e.g., bits B3-B4 of a field that indicates a maximum number of Supported EHT/UHR-LTFs).

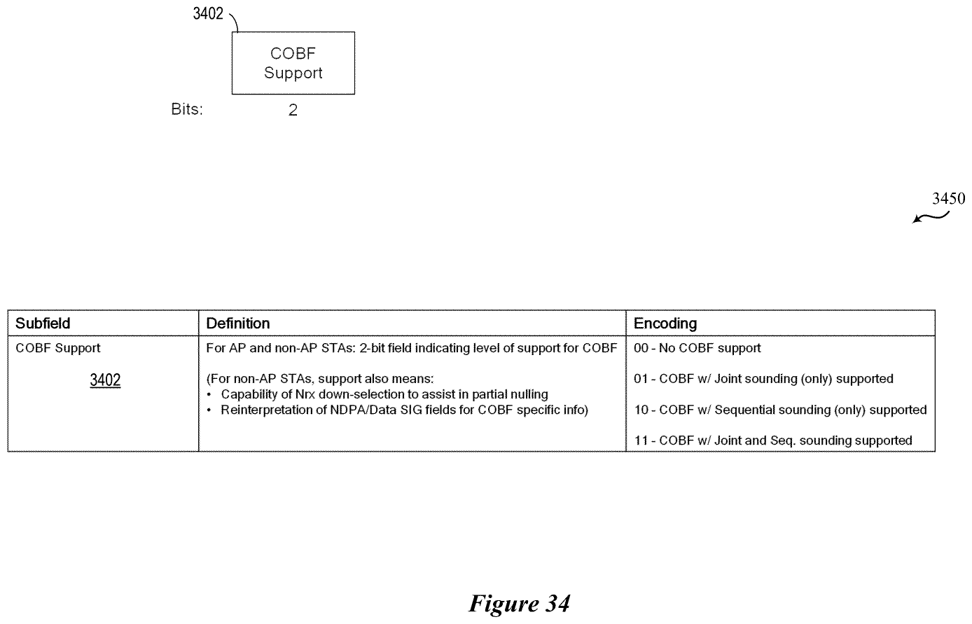

As illustrated in FIG. 34, in some cases, a field of bits 3402 (e.g., a 2-bit field) may be used to indicate, for AP and non-AP STAs, a level of support for COBF. As indicated in table 3450, for non-AP STAs, support may also involve capability of Nrx down-selection to assist in partial nulling and/or reinterpretation of NDPA/Data SIG fields for COBF specific information. As illustrated, different values of the 2-bit field may indicate support as:
00—No COBF support;
01—COBF w/Joint sounding (only) supported;
10—COBF w/Sequential sounding (only) supported; or
11—COBF w/Joint and Seq. sounding supported.

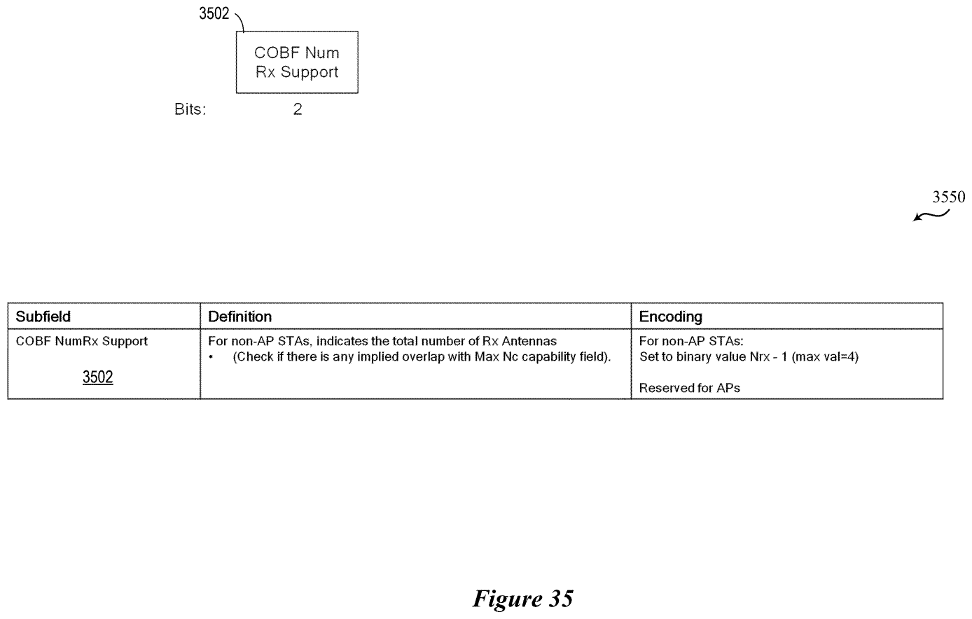

As illustrated in FIG. 35, in some cases, a field of bits 3502 may indicate, for non-AP STAs, a number of Rx antennas on the device. In some cases, there may be a range of Nrx possibilities (e.g., from 1 to 4 which may be indicated via 2 bits). This information may be helpful for an AP to decide whether to use full or partial nulling in COBF transmission. As indicated in table 3550, the two bits may explicitly indicate the number of Rx antennas for a non-AP STA or may be reserved for an AP.

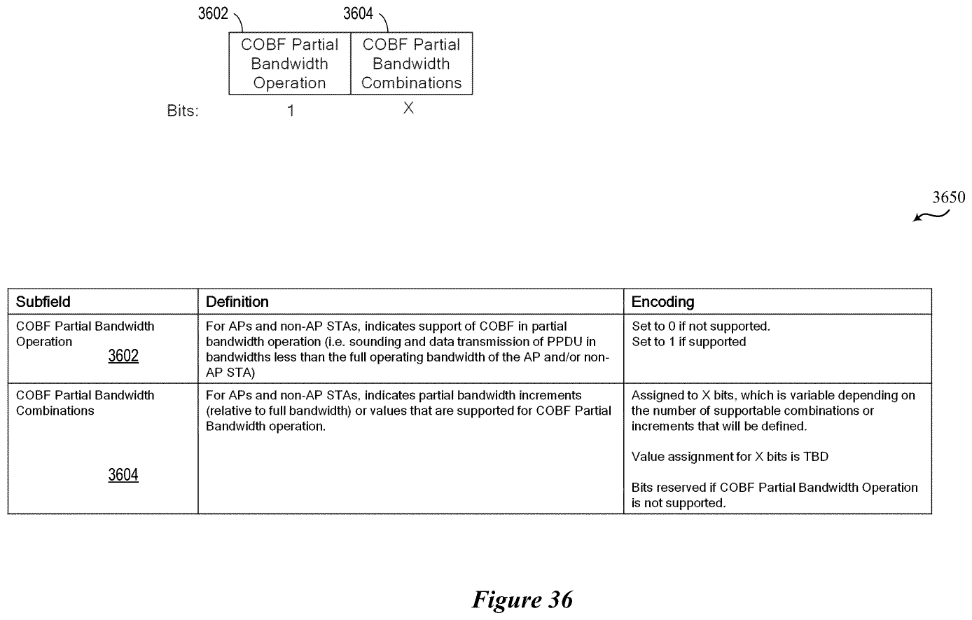

As illustrated in FIG. 36, in some cases, an additional field may indicate support for partial bandwidth operation. As indicated in table 3650, a first bit 3602 (COBF Partial Bandwidth Operation) may indicate, for APs and non-AP STAs, support of COBF in partial bandwidth operation (i.e. sounding and data transmission of PPDU in bandwidths less than the full operating bandwidth of the AP and/or non-AP STA). A second bit 3604 may indicate, for APs and non-AP STAs, partial bandwidth increments (relative to full bandwidth) or values that are supported for COBF Partial Bandwidth operation.

Aspects of the present disclosure provide mechanisms for signaling support for coordinated spatial reuse (CSR). CSR generally refers to a mechanism designed to improve network efficiency by allowing multiple APs and client devices to use the same frequency channel in a coordinated manner. This approach may help optimize the use of available spectrum and enhance overall network performance, especially in dense environments.

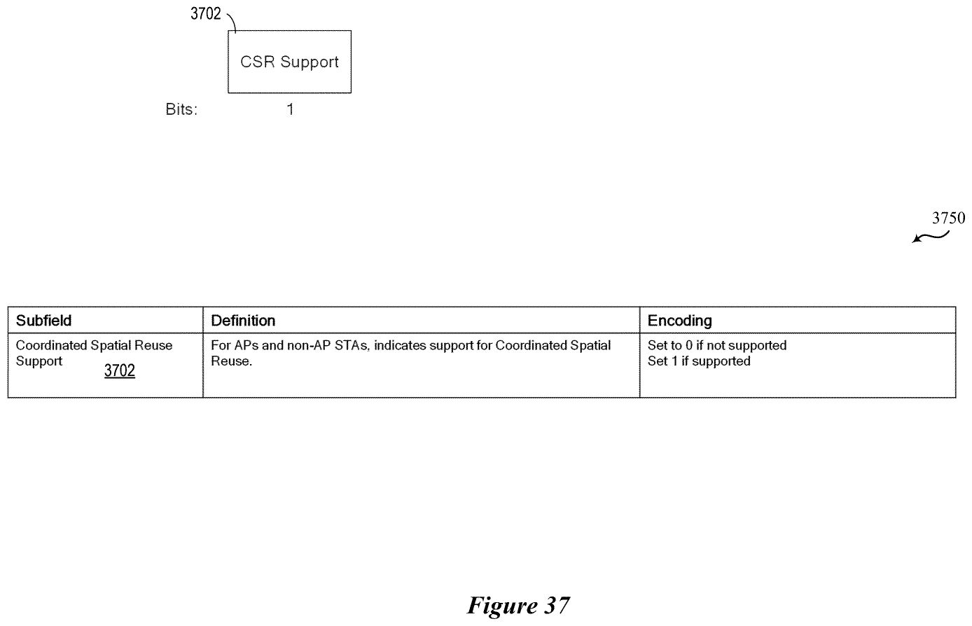

As illustrated in FIG. 37, in some cases, a single bit 3702 may indicate support for CSR. As indicated in table 3750, bit 3702 may simply indicate, for APs and non-AP STAs, support for CSR (e.g., with a 0 indicating no support and a 1 indicating support).

Aspects of the present disclosure provide mechanisms for signaling support for some type of interference mitigation mechanism (IMM). In some cases, IMM may involve transmission (and measurement) of Interference Mitigation pilots. These pilots may generally be any type of suitable signal (e.g., possibility something other than traditional pilots).

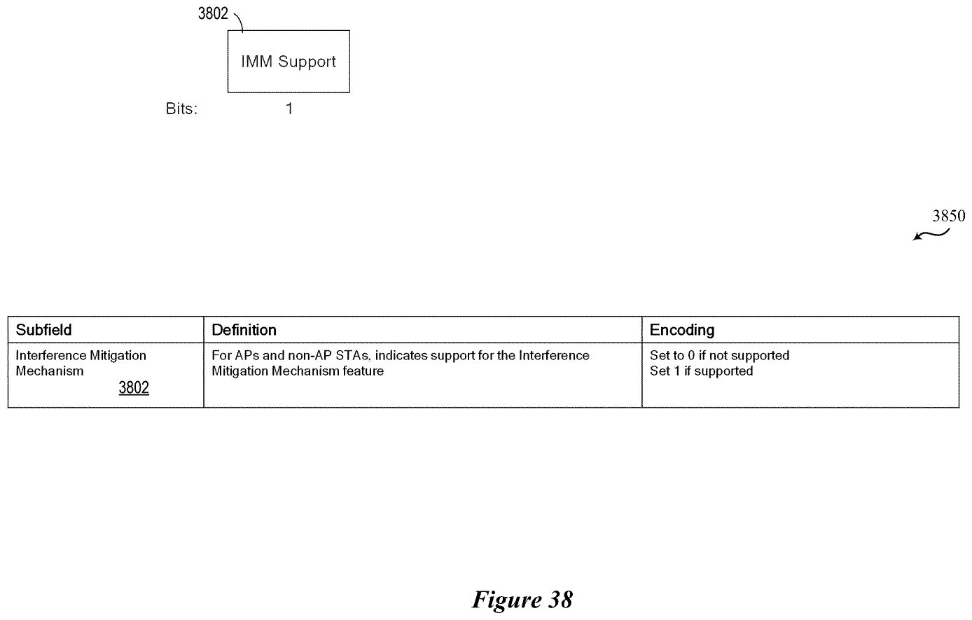

As illustrated in FIG. 38, in some cases, a single bit 3802 may indicate IMM support. As indicated in table 3750, bit 3802 may simply indicate, for APs and non-AP STAs, whether a device support an IMM feature (e.g., with a 0 indicating no support and a 1 indicating support).

### Example Methods

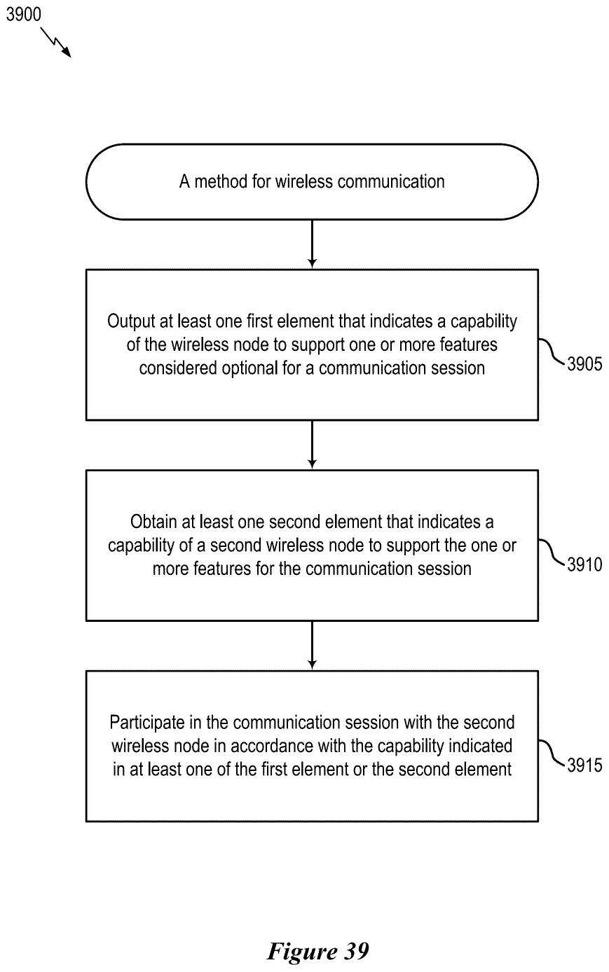

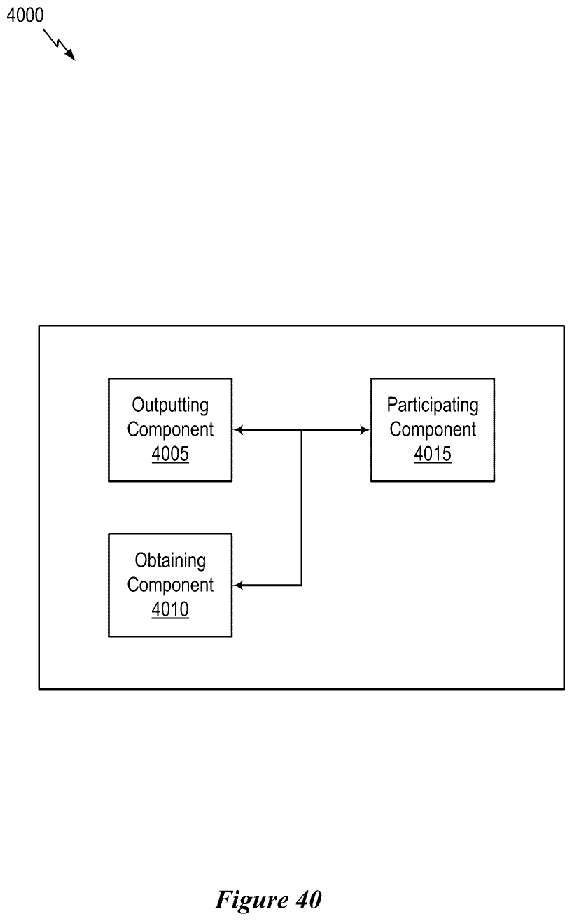

FIG. 39 shows a flowchart illustrating an example process 3900 performable by or at a wireless node that supports mechanisms for signaling support of optional wireless features. The operations of the process 3900 may be implemented by a wireless STA, or its components as described herein, and/or wireless AP, or its components as described herein. For example, the process 3900 may be performed by a wireless communication device, such as the wireless communication device 4000 described with reference to FIG. 40, operating as or within a wireless STA or operating as or within a wireless AP. In some examples, the process 3900 may be performed by a wireless STA such as one of the STAs 104 described with reference to FIG. 1. In some examples, the process 3900 may be performed by a wireless AP such as one of the APs 102 described with reference to FIG. 1.

In some examples, in block 3905, the wireless node may output at least one first element that indicates a capability of the wireless node to support one or more features considered optional for a communication session. In some cases, the operations of this step refer to, or may be performed by, an outputting component as described with reference to FIG. 40.

In some examples, in block 3910, the wireless node may obtain at least one second element that indicates a capability of a second wireless node to support the one or more features for the communication session. In some cases, the operations of this step refer to, or may be performed by, an obtaining component as described with reference to FIG. 40.

In some examples, in block 3915, the wireless node may participate in the communication session with the second wireless node in accordance with the capability indicated in at least one of the first element or the second element. In some cases, the operations of this step refer to, or may be performed by, a participating component as described with reference to FIG. 40.

In some aspects, the one or more features involve support of at least one low density parity check (LDPC) codeword size; and at least one of the first element or the second element indicates support associated with at least one transmission or reception associated with the at least one LDPC codeword size for one or more LDPC rates.

In some aspects, at least one of the first element or the second element indicates support associated the at least one LDPC codeword size associated with at least one of transmission or reception.

In some aspects, at least one of the first element or the second element indicates whether the wireless node supports the at least one LDPC codeword size associated with different LDPC rates.

In some aspects, the one or more features involve support of at least one low density parity check (LDPC) codeword size; and at least one of the first element or the second element indicates support associated with at least one transmission or reception associated with the at least one LDPC codeword size for a set of modulation and coding schemes (MCSs).

In some aspects, the at least one of the first element or the second element indicates the support via at least one field, wherein different values of the at least one field correspond to different sets of MCSs.

In some aspects, at least one of the first element or the second element indicates support associated with a set of one or more optional modulation and coding schemes (MCSs).

In some aspects, the support is indicated via support associated with a maximum MCS that is higher than the one or more of the MCSs.

In some aspects, at least one of the first element or the second element further indicates a maximum quantity of spatial streams for which the at least one of the optional MCSs is supported.

In some aspects, at least one of the first element or the second element further indicates support associated with all of the optional MCSs for both transmission and reception via a single bit.

In some aspects, the one or more features involve support of different modulation and coding schemes (MCSs) across different streams associated with a packet.

In some aspects, at least one of the first element or the second element indicates support associated with one or more patterns of different modulation and coding schemes (MCSs) supported across different streams associated with a packet.

In some aspects, each of the one or more patterns is associated with a maximum quantity of one or more spatial streams.

In some aspects, at least one of the first element or the second element further indicates at least one of: all of the patterns are supported for at least one of transmission or reception; all of the patterns associated with a maximum quantity of spatial streams or fewer spatial streams are supported; a subset of patterns are supported for different quantities of spatial streams; or a maximum difference in modulation and coding schemes (MCS) supported within a pattern for a given quantity of spatial streams.

In some aspects, at least one of the first element or the second element further indicates a maximum quantity of spatial streams for which different MCSs across different streams associated with a packet are supported; all of the patterns associated with the maximum quantity of spatial streams are supported; and all of the patterns associated with fewer spatial streams than the maximum quantity are supported.

In some aspects, at least one of the features involves support of distributed resource units (RUs).

In some aspects, at least one of the first element or the second element further indicates at least one of: support associated with distributed RUs for one or more operating bandwidths; support associated with distributed RUs for one or more distribution bandwidths; or support associated with distributed RUs for one or more punctured distribution bandwidths.

In some aspects, at least one of the first element or the second element further indicates support associated with both distributed RUs and regular RUs in a same packet.

In some aspects, the one or more features involve support associated with an extended long range (ELR) packet format.

In some aspects, at least one of the first element or the second element further indicates at least one of: support associated with the ELR packet format for one or more operating bandwidths; or support associated with the ELR packet format for at least one of transmission or reception.

In some aspects, at least one of the first element or the second element further indicates support associated with carrier frequency offset (CFO) pre-correction for transmission of the ELR packet format.

In some aspects, the one or more features involve support associated with coordinated beamforming (CoBF).

In some aspects, at least one of the first element or the second element further indicates at least one of: support associated with a joint sounding based on a packet simultaneously transmitted by multiple wireless nodes; or support associated with sequential sounding based on packets simultaneously transmitted by multiple wireless nodes.

In some aspects, at least one of the first element or the second element further indicates at least one of: a number of training fields supported for joint sounding; or a number of receive antennas.

In some aspects, at least one of the first element or the second element comprises a combination of bits encoded to indicate: no support associated with CoBF; support associated with CoBF with joint sounding supported; support associated with CoBF with sequential sounding supported; or support associated with CoBF with joint and sequential sounding supported.

In some aspects, at least one of the first element or the second element further indicates support associated with CoBF in less than full operating bandwidth.

In some aspects, the one or more features involve support associated with spatial reuse.

In some aspects, the one or more features involve support associated with reference signals or pilot sequences for interference mitigation.

Note that FIG. 39 is just one example of a process, and other processes including fewer, additional, or alternative steps are possible consistent with this disclosure.

### Example Device(s)

FIG. 40 shows a block diagram of an example wireless communication device 4000 that supports mechanisms for signaling support of optional wireless features. In some examples, the wireless communication device 4000 is configured to perform the process 3900 described with reference to FIG. 39. The wireless communication device 4000 may include one or more chips, SoCs, chipsets, packages, components or devices that individually or collectively constitute or include a processing system. The processing system may interface with other components of the wireless communication device 4000, and may generally process information (such as inputs or signals) received from such other components and output information (such as outputs or signals) to such other components. In some aspects, an example chip may include a processing system, a first interface to output or transmit information and a second interface to receive or obtain information. For example, the first interface may refer to an interface between the processing system of the chip and a transmission component, such that the device 4000 may transmit the information output from the chip. In such an example, the second interface may refer to an interface between the processing system of the chip and a reception component, such that the device 4000 may receive information that is passed to the processing system. In some such examples, the first interface also may obtain information, such as from the transmission component, and the second interface also may output information, such as to the reception component.

The processing system of the wireless communication device 4000 includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled with one or more of the processors and may individually or collectively store processor-executable code that, when executed by one or more of the processors, may configure one or more of the processors to perform various functions or operations described herein. Additionally or alternatively, in some examples, one or more of the processors may be preconfigured to perform various functions or operations described herein without requiring configuration by software. The processing system may further include or be coupled with one or more modems (such as a Wi-Fi (for example, IEEE compliant) modem or a cellular (for example, 3GPP 4G LTE, 5G or 6G compliant) modem). In some implementations, one or more processors of the processing system include or implement one or more of the modems. The processing system may further include or be coupled with multiple radios (collectively “the radio”), multiple RF chains or multiple transceivers, each of which may in turn be coupled with one or more of multiple antennas. In some implementations, one or more processors of the processing system include or implement one or more of the radios, RF chains or transceivers.

In some examples, the wireless communication device 4000 can be configurable or configured for use in a STA, such as the STA 104 described with reference to FIG. 1. In some other examples, the wireless communication device 4000 can be a STA that includes such a processing system and other components including multiple antennas. In some examples, the wireless communication device 4000 can be configurable or configured for use in an AP, such as the AP 102 described with reference to FIG. 1. In some other examples, the wireless communication device 4000 can be an AP that includes such a processing system and other components including multiple antennas. The wireless communication device 4000 is capable of transmitting and receiving wireless communications in the form of, for example, wireless packets. For example, the wireless communication device 4000 can be configurable or configured to transmit and receive packets in the form of physical layer PPDUs and MPDUs conforming to one or more of the IEEE 802.11 family of wireless communication protocol standards. In some other examples, the wireless communication device 4000 can be configurable or configured to transmit and receive signals and communications conforming to one or more 3GPP specifications including those for 5G NR or 6G. In some examples, the wireless communication device 4000 also includes or can be coupled with one or more application processors which may be further coupled with one or more other memories. In some examples, the wireless communication device 4000 further includes a user interface (UI) (such as a touchscreen or keypad) and a display, which may be integrated with the UI to form a touchscreen display that is coupled with the processing system. In some examples, the wireless communication device 4000 may further include one or more sensors such as, for example, one or more inertial sensors, accelerometers, temperature sensors, pressure sensors, or altitude sensors, that are coupled with the processing system. In some examples, the wireless communication device 4000 further includes at least one external network interface coupled with the processing system that enables communication with a core network or backhaul network that enables the wireless communication device 4000 to gain access to external networks including the Internet.

The wireless communication device 4000 includes outputting component 4005, obtaining component 4010, and participating component 4015. Portions of one or more of the components 4005, 4010, and 4015 may be implemented at least in part in hardware or firmware. For example one or more of the components 4005, 4010, and 4015 may be implemented at least in part by a processor or a modem. In some examples, portions of one or more of the components 4005, 4010, and 4015 may be implemented at least in part by a processor and software in the form of processor-executable code stored in a memory.

### EXAMPLE CLAUSES

Clause 1: A method for wireless communication at a wireless node, including: outputting at least one first element that indicates a capability of the wireless node to support one or more features considered optional for a communication session; obtaining at least one second element that indicates a capability of a second wireless node to support the one or more features for the communication session; and participating in the communication session with the second wireless node in accordance with the capability indicated in at least one of the first element or the second element.
Clause 2: The method of Clause 1, where the one or more features involve support of at least one low density parity check (LDPC) codeword size; and at least one of the first element or the second element indicates support associated with at least one transmission or reception associated with the at least one LDPC codeword size for one or more LDPC rates.
Clause 3: The method of Clause 2, where at least one of the first element or the second element indicates support associated the at least one LDPC codeword size associated with at least one of transmission or reception.
Clause 4: The method of Clause 2, where at least one of the first element or the second element indicates whether the wireless node supports the at least one LDPC codeword size associated with different LDPC rates.
Clause 5: The method any one of Clauses 1-4, where the one or more features involve support of at least one low density parity check (LDPC) codeword size; and at least one of the first element or the second element indicates support associated with at least one transmission or reception associated with the at least one LDPC codeword size for a set of modulation and coding schemes (MCSs).
Clause 6: The method of Clause 5, where the at least one of the first element or the second element indicates the support via at least one field, wherein different values of the at least one field correspond to different sets of MCSs.
Clause 7: The method any one of Clauses 1-6, where at least one of the first element or the second element indicates support associated with a set of one or more optional modulation and coding schemes (MCSs).
Clause 8: The method of Clause 7, where the support is indicated via support associated with a maximum MCS that is higher than the one or more of the MCSs.
Clause 9: The method of Clause 7, where at least one of the first element or the second element further indicates a maximum quantity of spatial streams for which the at least one of the optional MCSs is supported.
Clause 10: The method of Clause 7, where at least one of the first element or the second element further indicates support associated with all of the optional MCSs for both transmission and reception via a single bit.
Clause 11: The method any one of Clauses 1-10, where the one or more features involve support of different modulation and coding schemes (MCSs) across different streams associated with a packet.
Clause 12: The method any one of Clauses 1-11, where at least one of the first element or the second element indicates support associated with one or more patterns of different modulation and coding schemes (MCSs) supported across different streams associated with a packet.
Clause 13: The method of Clause 12, where each of the one or more patterns is associated with a maximum quantity of one or more spatial streams.
Clause 14: The method of Clause 13, where at least one of the first element or the second element further indicates at least one of: all of the patterns are supported for at least one of transmission or reception; all of the patterns associated with a maximum quantity of spatial streams or fewer spatial streams are supported; a subset of patterns are supported for different quantities of spatial streams; or a maximum difference in modulation and coding schemes (MCS) supported within a pattern for a given quantity of spatial streams.
Clause 15: The method of Clause 12, where at least one of the first element or the second element further indicates a maximum quantity of spatial streams for which different MCSs across different streams associated with a packet are supported; all of the patterns associated with the maximum quantity of spatial streams are supported; and all of the patterns associated with fewer spatial streams than the maximum quantity are supported.
Clause 16: The method any one of Clauses 1-15, where at least one of the features involves support of distributed resource units (RUs).
Clause 17: The method of Clause 16, where at least one of the first element or the second element further indicates at least one of: support associated with distributed RUs for one or more operating bandwidths; support associated with distributed RUs for one or more distribution bandwidths; or support associated with distributed RUs for one or more punctured distribution bandwidths.
Clause 18: The method of Clause 16, where at least one of the first element or the second element further indicates support associated with both distributed RUs and regular RUs in a same packet.
Clause 19: The method any one of Clauses 1-18, where the one or more features involve support associated with an extended long range (ELR) packet format.
Clause 20: The method of Clause 19, where at least one of the first element or the second element further indicates at least one of: support associated with the ELR packet format for one or more operating bandwidths; or support associated with the ELR packet format for at least one of transmission or reception.
Clause 21: The method of Clause 19, where at least one of the first element or the second element further indicates support associated with carrier frequency offset (CFO) pre-correction for transmission of the ELR packet format.
Clause 22: The method any one of Clauses 1-21, where the one or more features involve support associated with coordinated beamforming (CoBF).
Clause 23: The method of Clause 22, where at least one of the first element or the second element further indicates at least one of: support associated with a joint sounding based on a packet simultaneously transmitted by multiple wireless nodes; or support associated with sequential sounding based on packets simultaneously transmitted by multiple wireless nodes.
Clause 24: The method of Clause 23, where at least one of the first element or the second element further indicates at least one of: a quantity of training fields supported for joint sounding; or a quantity of receive antennas.
Clause 25: The method of Clause 23, where at least one of the first element or the second element includes a combination of bits encoded to indicate: no support associated with CoBF; support associated with CoBF with joint sounding supported; support associated with CoBF with sequential sounding supported; or support associated with CoBF with joint and sequential sounding supported.
Clause 26: The method of Clause 22, where at least one of the first element or the second element further indicates support associated with CoBF in less than full operating bandwidth.
Clause 27: The method any one of Clauses 1-26, where the one or more features involve support associated with spatial reuse.
Clause 28: The method any one of Clauses 1-27, where the one or more features involve support associated with reference signals or pilot sequences for interference mitigation.
Clause 29: An apparatus, including: at least one memory including executable instructions; and at least one processor configured to execute the executable instructions and cause the apparatus to perform a method in accordance with any combination of Clauses 1-28.
Clause 30: An apparatus, including means for performing a method in accordance with any combination of Clauses 1-28.
Clause 31: A non-transitory computer-readable medium including executable instructions that, when executed by at least one processor of an apparatus, cause the apparatus to perform a method in accordance with any combination of Clauses 1-28.
Clause 32: A computer program product embodied on a computer-readable storage medium including code for performing a method in accordance with any combination of Clauses 1-28.
Clause 33: A wireless node (e.g., an AP or non-AP STA), including: at least one transceiver; at least one memory including executable instructions; and at least one processor configured to execute the executable instructions and cause the wireless node to perform a method in accordance with any combination of Clauses 1-28, wherein the at least one transceiver is configured transmit the at least one first element and receive the at least one second element.

### ADDITIONAL CONSIDERATIONS

As used herein, the term “determine” or “determining” encompasses a wide variety of actions and, therefore, “determining” can include calculating, computing, processing, deriving, investigating, looking up (such as via looking up in a table, a database or another data structure), inferring, ascertaining, measuring, and the like. Also, “determining” can include receiving (such as receiving information), accessing (such as accessing data stored in memory), transmitting (such as transmitting information) and the like. Also, “determining” can include resolving, selecting, obtaining, choosing, establishing and other such similar actions.

Means for outputting, means for participating, and means for obtaining may comprise one or more processors, such as one or more of the processors described above with reference to FIG. 40.

As used herein, a phrase referring to “at least one of” a list of items refers to any combination of those items, including single members. As an example, “at least one of a, b, or c” is intended to cover: a, b, c, a-b, a-c, b-c, and a-b-c. As used herein, “or” is intended to be interpreted in the inclusive sense, unless otherwise explicitly indicated. For example, “a or b” may include a only, b only, or a combination of a and b.

As used herein, “based on” is intended to be interpreted in the inclusive sense, unless otherwise explicitly indicated. For example, “based on” may be used interchangeably with “based at least in part on,” “associated with”, or “in accordance with” unless otherwise explicitly indicated. Specifically, unless a phrase refers to “based on only ‘a,’” or the equivalent in context, whatever it is that is “based on ‘a,’” or “based at least in part on ‘a,’” may be based on “a” alone or based on a combination of “a” and one or more other factors, conditions or information.

The various illustrative components, logic, logical blocks, modules, circuits, operations and algorithm processes described in connection with the examples disclosed herein may be implemented as electronic hardware, firmware, software, or combinations of hardware, firmware or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

As used herein, “a processor,” “at least one processor” or “one or more processors” generally refers to a single processor configured to perform one or multiple operations or multiple processors configured to collectively perform one or more operations. In the case of multiple processors, performance the one or more operations could be divided amongst different processors, though one processor may perform multiple operations, and multiple processors could collectively perform a single operation. Similarly, “a memory,” “at least one memory” or “one or more memories” generally refers to a single memory configured to store data and/or instructions, multiple memories configured to collectively store data and/or instructions.

In some cases, rather than actually transmitting a signal, an apparatus (e.g., a wireless node or device) may have an interface to output the signal for transmission. For example, a processor may output a signal, via a bus interface, to a radio frequency (RF) front end for transmission. Accordingly, a means for outputting may include such an interface as an alternative (or in addition) to a transmitter or transceiver. Similarly, rather than actually receiving a signal, an apparatus (e.g., a wireless node or device) may have an interface to obtain a signal from another device. For example, a processor may obtain (or receive) a signal, via a bus interface, from an RF front end for reception. Accordingly, a means for obtaining may include such an interface as an alternative (or in addition) to a receiver or transceiver.

While the present disclosure may describe certain operations as being performed by one type of wireless node, the same or similar operations may also be performed by another type of wireless node. For example, operations performed by an AP STA may also (or instead) be performed by a non-AP STA. Similarly, operations performed by a non-AP STA may also (or instead) be performed by an AP STA.

Further, while the present disclosure may describe certain types of communications between different types of wireless nodes (e.g., between an AP STA and a non-AP STA), the same or similar types of communications may occur between same types of wireless nodes (e.g., between AP STAs or between non-AP STAs, in a peer-to-peer scenario). Further, communications may occur in reverse order than described.

Various modifications to the examples described in this disclosure may be readily apparent to persons having ordinary skill in the art, and the generic principles defined herein may be applied to other examples without departing from the spirit or scope of this disclosure. Thus, the claims are not intended to be limited to the examples shown herein, but are to be accorded the widest scope consistent with this disclosure, the principles and the novel features disclosed herein.

Additionally, various features that are described in this specification in the context of separate examples also can be implemented in combination in a single implementation. Conversely, various features that are described in the context of a single implementation also can be implemented in multiple examples separately or in any suitable sub combination. As such, although features may be described above as acting in particular combinations, and even initially claimed as such, one or more features from a claimed combination can in some cases be excised from the combination, and the claimed combination may be directed to a sub combination or variation of a sub combination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the examples described above should not be understood as requiring such separation in all examples, and it should be understood that the described program components and systems can generally be integrated together in a single software product or packaged into multiple software products.

1. An apparatus for wireless communication, comprising:
at least one memory comprising computer-executable instructions; and
one or more processors configured to execute the computer-executable instructions and cause the apparatus to:
output at least one first element that indicates a capability of the apparatus to support one or more features considered optional for a communication session;
obtain at least one second element that indicates a capability of a wireless node to support the one or more features for the communication session; and
participate in the communication session with the wireless node in accordance with the capability indicated in at least one of the first element or the second element.

2. The apparatus of claim 1, wherein:
the one or more features involve support of at least one low density parity check (LDPC) codeword size; and
at least one of the first element or the second element indicates support associated with at least one transmission or reception associated with the at least one LDPC codeword size for one or more LDPC rates.

3. The apparatus of claim 2, wherein at least one of the first element or the second element indicates support associated the at least one LDPC codeword size associated with at least one of transmission or reception.

4. The apparatus of claim 2, wherein at least one of the first element or the second element indicates whether the apparatus supports the at least one LDPC codeword size associated with different LDPC rates.

5. The apparatus of claim 1, wherein:
the one or more features involve support of at least one low density parity check (LDPC) codeword size; and
at least one of the first element or the second element indicates support associated with at least one transmission or reception associated with the at least one LDPC codeword size for a set of modulation and coding schemes (MCSs).

6. The apparatus of claim 5, wherein the at least one of the first element or the second element indicates the support via at least one field, wherein different values of the at least one field correspond to different sets of MCSs.

7. The apparatus of claim 1, wherein:
at least one of the first element or the second element indicates support associated with a set of one or more optional modulation and coding schemes (MCSs).

8. The apparatus of claim 7, wherein the support is indicated via support associated with a maximum MCS that is higher than the one or more of the MCSs.

9. The apparatus of claim 7, wherein at least one of the first element or the second element further indicates a maximum quantity of spatial streams for which the at least one of the optional MCSs is supported.

10. The apparatus of claim 7, wherein at least one of the first element or the second element further indicates support associated with all of the optional MCSs for both transmission and reception via a single bit.

11. The apparatus of claim 1, wherein:
the one or more features involve support of different modulation and coding schemes (MCSs) across different streams associated with a packet.

12. The apparatus of claim 1, wherein at least one of the first element or the second element indicates support associated with one or more patterns of different modulation and coding schemes (MCSs) supported across different streams associated with a packet.

13. The apparatus of claim 12, wherein each of the one or more patterns is associated with a maximum quantity of one or more spatial streams.

14. The apparatus of claim 13, wherein at least one of the first element or the second element further indicates at least one of:
all of the patterns are supported for at least one of transmission or reception;
all of the patterns associated with a maximum quantity of spatial streams or fewer spatial streams are supported;
a subset of patterns are supported for different quantities of spatial streams; or
a maximum difference in modulation and coding schemes (MCS) supported within a pattern for a given quantity of spatial streams.

15. The apparatus of claim 12, wherein:
at least one of the first element or the second element further indicates a maximum quantity of spatial streams for which different MCSs across different streams associated with a packet are supported;
all of the patterns associated with the maximum quantity of spatial streams are supported; and
all of the patterns associated with fewer spatial streams than the maximum quantity are supported.

16. The apparatus of claim 1, wherein:
at least one of the features involves support of distributed resource units (RUs).

17. The apparatus of claim 16, wherein at least one of the first element or the second element further indicates at least one of:
support associated with distributed RUs for one or more operating bandwidths;
support associated with distributed RUs for one or more distribution bandwidths; or
support associated with distributed RUs for one or more punctured distribution bandwidths.

18. The apparatus of claim 16, wherein at least one of the first element or the second element further indicates support associated with both distributed RUs and regular RUs in a same packet.

19. The apparatus of claim 1, wherein:
the one or more features involve support associated with an extended long range (ELR) packet format.

20. The apparatus of claim 19, wherein at least one of the first element or the second element further indicates at least one of:
support associated with the ELR packet format for one or more operating bandwidths; or
support associated with the ELR packet format for at least one of transmission or reception.

21. The apparatus of claim 19, wherein at least one of the first element or the second element further indicates support associated with carrier frequency offset (CFO) pre-correction for transmission of the ELR packet format.

22. The apparatus of claim 1, wherein:
the one or more features involve support associated with coordinated beamforming (CoBF).

23. The apparatus of claim 22, wherein at least one of the first element or the second element further indicates at least one of:
support associated with a joint sounding based on a packet simultaneously transmitted by multiple wireless nodes; or
support associated with sequential sounding based on packets simultaneously transmitted by multiple wireless nodes.

24. The apparatus of claim 23, wherein at least one of the first element or the second element further indicates at least one of:
a quantity of training fields supported for joint sounding; or
a quantity of receive antennas.

25. The apparatus of claim 23, wherein at least one of the first element or the second element comprises a combination of bits encoded to indicate:
no support associated with CoBF;
support associated with CoBF with joint sounding supported;
support associated with CoBF with sequential sounding supported; or
support associated with CoBF with joint and sequential sounding supported.

26. The apparatus of claim 22, wherein at least one of the first element or the second element further indicates support associated with CoBF in less than full operating bandwidth.

27. The apparatus of claim 1, wherein:
the one or more features involve support associated with spatial reuse.

28. The apparatus of claim 1, wherein:
the one or more features involve support associated with reference signals or pilot sequences for interference mitigation.

29. A method for wireless communication at a first wireless node, comprising:
outputting at least one first element that indicates a capability of the first wireless node to support one or more features considered optional for a communication session;
obtaining at least one second element that indicates a capability of a second wireless node to support the one or more features for the communication session; and
participating in the communication session with the second wireless node in accordance with the capability indicated in at least one of the first element or the second element.

30. A first wireless node, comprising:
at least one transceiver;
at least one memory comprising computer-executable instructions; and
one or more processors configured to execute the computer-executable instructions and cause the first wireless node to:
transmit, via the at least one transceiver, at least one first element that indicates a capability of the first wireless node to support one or more features considered optional for a communication session;
receive, via the at least one transceiver, at least one second element that indicates a capability of a second wireless node to support the one or more features for the communication session; and
participate in the communication session with the second wireless node in accordance with the capability indicated in at least one of the first element or the second element.
